(19) United States
(12) Patent Application Publication
(10) Pub. No.: US 2025/0206403 A1
(43) Pub. Date: Jun. 26, 2025

(54) ELECTRIC DEVICE AND CONTROL SYSTEM OF HUMAN-POWERED VEHICLE

(71) Applicant: SHIMANO INC., Sakai City (JP)

(72) Inventors: Kentaro TANAKA, Sakai City (JP); Noor Ashyikkin BINTI MOHD NOOR, Sakai City (JP); Toyoto SHIRAI, Sakai City (JP); Satoshi SHAHANA, Sakai City (JP); Yuki SAKAGAWA, Sakai City (JP); Nobukatsu HARA, Sakai City (JP)

(73) Assignee: SHIMANO INC., Sakai City (JP)

(21) Appl. No.: 18/391,528

(22) Filed: Dec. 20, 2023

(51) Int. Cl. B62J 45/20; B60T 8/17; B62J 1/06; B62K 25/02; B62K 25/04; B62M 6/45

(52) U.S. Cl. CPC B62J 45/20; B60T 8/1706; B62J 1/06; B62K 25/02; B62K 25/04; B62M 6/45

(57) ABSTRACT

An electric device of a human-powered vehicle comprises first wireless communicator circuitry and electronic controller circuitry. The first wireless communicator circuitry is configured to wirelessly communicate with second wireless communicator circuitry of a second electric device. The electronic controller circuitry is electrically connected to the first wireless communicator circuitry. The electronic controller circuitry is configured to obtain information relating to a positional relationship between the first wireless communicator circuitry and the second wireless communicator circuitry so as to generate at least one control signal based on the information.

### BACKGROUND

### Technical Field

The present invention relates to an electric device and a control system of a human-powered vehicle.

### Background Information

A human-powered vehicle includes at least one device. One of objects of the present disclosure is to flexibly control the device depending on a positional relationship between two devices with a comparatively simple structure.

### SUMMARY

In accordance with a first aspect of the present invention, an electric device of a human-powered vehicle comprises first wireless communicator circuitry and electronic controller circuitry. The first wireless communicator circuitry is configured to wirelessly communicate with second wireless communicator circuitry of a second electric device. The electronic controller circuitry is electrically connected to the first wireless communicator circuitry. The electronic controller circuitry is configured to obtain information relating to a positional relationship between the first wireless communicator circuitry and the second wireless communicator circuitry so as to generate at least one control signal based on the information.

With the electric device according to the first aspect, it is possible to control a device using the at least one control signal generated based on the positional relationship between the first wireless communicator circuitry and the second wireless communicator circuitry. Furthermore, it is possible to omit an electric cable since the first wireless communicator circuitry and the second wireless communicator circuitry are used to obtain the positional relationship. Thus, it is possible to flexibly control the device depending on the positional relationship with a comparatively simple structure.

In accordance with a second aspect of the present invention, the electric device according to the first aspect is configured so that the information includes directional information relating to a directional relationship between the first wireless communicator circuitry and the second wireless communicator circuitry in the human-powered vehicle. The electronic controller circuitry is configured to obtain the directional information.

With the electric device according to the second aspect, it is possible to control the device based on the directional relationship between the first wireless communicator circuitry and the second wireless communicator circuitry. Thus, it is possible to control the device more flexibly depending on the directional relationship with a comparatively simple structure.

In accordance with a third aspect of the present invention, the electric device according to the second aspect is configured so that the electronic controller circuitry is configured to generate the at least one control signal based on the directional information.

With the electric device according to the third aspect, it is possible to control the device using the at least one control signal generated based on the directional relationship. Thus, it is possible to reliably control the device depending on the directional relationship with a comparatively simple structure.

In accordance with a fourth aspect of the present invention, the electric device according to the second or third aspect is configured so that the directional information includes an angle of arrival defined based on a relative position between the first wireless communicator circuitry and the second wireless communicator circuitry. The electronic controller circuitry is configured to obtain the angle of arrival.

With the electric device according to the fourth aspect, it is possible to reliably obtain the positional relationship between the first wireless communicator circuitry and the second wireless communicator circuitry based on the angle of arrival. Thus, it is possible to control the device precisely with a comparatively simple structure.

In accordance with a fifth aspect of the present invention, the electric device according to the fourth aspect is configured so that the electronic controller circuitry is configured to generate the at least one control signal based on the angle of arrival.

With the electric device according to the fifth aspect, it is possible to control the device precisely and reliably using the at least one control signal with a comparatively simple structure.

In accordance with a sixth aspect of the present invention, the electric device according to the fourth or fifth aspect is configured so that the first wireless communicator circuitry includes at least two first antennas.

With the electric device according to the sixth aspect, it is possible to obtain the positional relationship with a comparatively simple structure.

In accordance with a seventh aspect of the present invention, the electric device according to the sixth aspect is configured so that a total number of the at least two first antennas is greater than or equal to three.

With the electric device according to the seventh aspect, it is possible to precisely obtain positional relationship with a comparatively simple structure.

In accordance with an eighth aspect of the present invention, the electric device according to the sixth or seventh aspect is configured so that the at least two first antennas are equally spaced.

With the electric device according to the eighth aspect, it is possible to obtain positional relationship more precisely with a comparatively simple structure.

In accordance with a ninth aspect of the present invention, the electric device according to any one of the fourth to eighth aspects is configured so that the angle of arrival is defined based on a positional relationship between the at least two first antennas and a second antenna of the second wireless communicator circuitry in the human-powered vehicle.

With the electric device according to the ninth aspect, it is possible to precisely obtain the positional relationship with a comparatively simple structure.

In accordance with a tenth aspect of the present invention, the electric device according to the second or third aspect is configured so that the directional information includes an angle of departure defined based on a relative position between the first wireless communicator circuitry and the second wireless communicator circuitry. The electronic controller circuitry is configured to obtain the angle of departure.

With the electric device according to the tenth aspect, it is possible to reliably obtain the positional relationship between the first wireless communicator circuitry and the second wireless communicator circuitry based on the angle of departure. Thus, it is possible to control the device precisely with a comparatively simple structure.

In accordance with an eleventh aspect of the present invention, the electric device according to the tenth aspect is configured so that the electronic controller circuitry is configured to generate the at least one control signal based on the angle of departure.

With the electric device according to the eleventh aspect, it is possible to control the device precisely and reliably using the at least one control signal with a comparatively simple structure.

In accordance with a twelfth aspect of the present invention, the electric device according to the tenth or eleventh aspect is configured so that the first wireless communicator circuitry includes a first antenna.

With the electric device according to the twelfth aspect, it is possible to obtain the positional relationship with a comparatively simple structure.

In accordance with a thirteenth aspect of the present invention, the electric device according to any one of the tenth to twelfth aspects is configured so that the angle of departure is defined based on a positional relationship between the first antenna and at least two second antennas of the second wireless communicator circuitry in the human-powered vehicle.

With the electric device according to the thirteenth aspect, it is possible to precisely obtain the positional relationship with a comparatively simple structure.

In accordance with a fourteenth aspect of the present invention, the electric device according to any one of the first to thirteenth aspects further comprises one of an operating device, an adjustable seatpost, a gear changer, a suspension, a brake device, an assist drive unit, and a wearable device.

With the electric device according to the fourteenth aspect, it is possible to control the device based on the positional relationship between the second wireless communicator circuitry and the one of the operating device, the adjustable seatpost, the gear changer, the suspension, the brake device, the assist drive unit, and the wearable device.

In accordance with a fifteenth aspect of the present invention, the electric device according to the fourteenth aspect is configured so that the second electric device includes another of the operating device, the adjustable seatpost, the gear changer, the suspension, the brake device, the assist drive unit, and the wearable device.

With the electric device according to the fifteenth aspect, it is possible to control the device based on the positional relationship between the one of the operating device, the adjustable seatpost, the gear changer, the suspension, the brake device, the assist drive unit, and the wearable device and another of the operating device, the adjustable seatpost, the gear changer, the suspension, the brake device, the assist drive unit, and the wearable device.

In accordance with a sixteenth aspect of the present invention, a control system of a human-powered vehicle comprises the electric device according to any one of the first to fifteenth aspects, a sensor, and an additional electric device. The sensor is configured to be connected to at least one of the first wireless communicator circuitry, the second wireless communicator circuitry and the electronic controller circuitry. The sensor is configured to transmit the information relating to the positional relationship to the electronic controller circuitry. The additional electric device is configured to be controlled by at least one control signal generated by the electronic controller circuitry.

With the control system according to the sixteenth aspect, it is possible to reliably control the additional electric device based on the positional relationship with a comparatively simple structure.

In accordance with a seventeenth aspect of the present invention, the electric device according to the sixteenth aspect is configured so that the additional electric device includes one of the adjustable seatpost, the gear changer, the suspension, the brake device, and the assist drive unit.

With the electric device according to the seventeenth aspect, it is possible to reliably control the additional electric device based on the positional relationship between the first wireless communicator circuitry and the one of the adjustable seatpost, the gear changer, the suspension, the brake device, and the assist drive unit.

In accordance with an eighteenth aspect of the present invention, a control system of a human-powered vehicle comprises electronic controller circuitry. The electronic controller circuitry is configured to generate at least one control signal based on motion information relating to whether a motion state of a rider falls outside a predetermined range. The electronic controller circuitry is configured to limit, based on the at least one control signal, a function of a device which is functional with respect to the human-powered vehicle.

With the electric device according to the eighteenth aspect, it is possible to efficiently control the device using the motion information.

In accordance with a nineteenth aspect of the present invention, the electric device according to the eighteenth aspect is configured so that the motion information includes fluctuation in a running condition of the human-powered vehicle for a predetermined time.

With the electric device according to the nineteenth aspect, it is possible to efficiently control the device using the fluctuation in the running condition of the human-powered vehicle.

In accordance with a twentieth aspect of the present invention, the electric device according to the nineteenth aspect is configured so that the fluctuation in the running condition relates to at least one of a tire air pressure, a vehicle acceleration, a handlebar load, a saddle load, an assist power output, a rider's motion, a chain state, and a running speed of the human-powered vehicle.

With the electric device according to the twentieth aspect, it is possible to control the device more efficiently using the fluctuation in the running condition of the human-powered vehicle.

In accordance with a twenty-first aspect of the present invention, the electric device according to any one of the eighteenth to twentieth aspects is configured so that the at least one control signal includes at least: a first limiting control signal to limit the function of the device to a first operating state; a second limiting control signal to set the device to a second operating state different from the first operating state; and a third limiting control signal to set the device to a third operating state different from the first operating state and the second operating state.

With the electric device according to the twenty-first aspect, it is possible to control the device more efficiently using the fluctuation in the running condition of the human-powered vehicle.

In accordance with a twenty-second aspect of the present invention, the electric device according to any one of the first to twenty-first aspects is configured so that the electronic controller circuitry is configured to generate the at least one control signal to change a state of a suspension between at least two states based on the information.

With the electric device according to the twenty-second aspect, it is possible to change the state of the suspension based on the positional relationship between the first wireless communicator circuitry and the second wireless communicator circuitry.

In accordance with a twenty-third aspect of the present invention, the electric device according to any one of the first to twenty-second aspects is configured so that the electronic controller circuitry is configured to generate the at least one control signal to change a state of an adjustable seatpost between at least two states based on the information.

With the electric device according to the twenty-third aspect, it is possible to change the state of the adjustable seatpost based on the positional relationship between the first wireless communicator circuitry and the second wireless communicator circuitry.

In accordance with a twenty-fourth aspect of the present invention, the electric device according to any one of the first to twenty-third aspects is configured so that the electronic controller circuitry is configured to generate the at least one control signal to restrict a brake device from generating a braking force based on the information.

With the electric device according to the twenty-fourth aspect, it is possible to restrict the brake device based on the positional relationship between the first wireless communicator circuitry and the second wireless communicator circuitry.

In accordance with a twenty-fifth aspect of the present invention, the electric device according to any one of the first to twenty-fourth aspects is configured so that the electronic controller circuitry is configured to generate the at least one control signal to change an assist ratio of an assist drive unit based on the information.

With the electric device according to the twenty-fifth aspect, it is possible to change the assist ratio of the assist drive unit based on the positional relationship between the first wireless communicator circuitry and the second wireless communicator circuitry.

In accordance with a twenty-sixth aspect of the present invention, the electric device according to any one of the first to twenty-fifth aspects is configured so that the electronic controller circuitry is configured to generate the at least one control signal to change a gear ratio of a gear changer based on the information.

With the electric device according to the twenty-sixth aspect, it is possible to change the gear ratio of the gear changer based on the positional relationship between the first wireless communicator circuitry and the second wireless communicator circuitry.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1 is a side elevational view of a human-powered vehicle including a control system in accordance with one of embodiments.

FIGS. 2 to 5 are schematic block diagrams of the control system of the human-powered vehicle illustrated in FIG. 1.

FIGS. 6 and 7 are schematic block diagrams showing an angle of arrival.

FIGS. 8 and 9 are schematic block diagrams showing an angle of departure.

FIGS. 10 to 17 are flowcharts showing a first control executed by the control system of the human-powered vehicle illustrated in FIG. 1.

FIG. 18 is a schematic block diagram of the control system of the human-powered vehicle in accordance with a modification.

FIG. 19 is a table showing limiting control signals, operating states, and actions of the control system of the human-powered vehicle in accordance with the modification.

FIG. 20 is a flowchart showing a second control executed by the control system of the human-powered vehicle in accordance with the modification.

FIG. 21 is a side elevational view of a crank and a device of the control system illustrated in FIG. 4.

### DESCRIPTION OF THE EMBODIMENTS

The embodiments will now be described with reference to the accompanying drawings, wherein like reference numerals designate corresponding or identical elements throughout the various drawings.

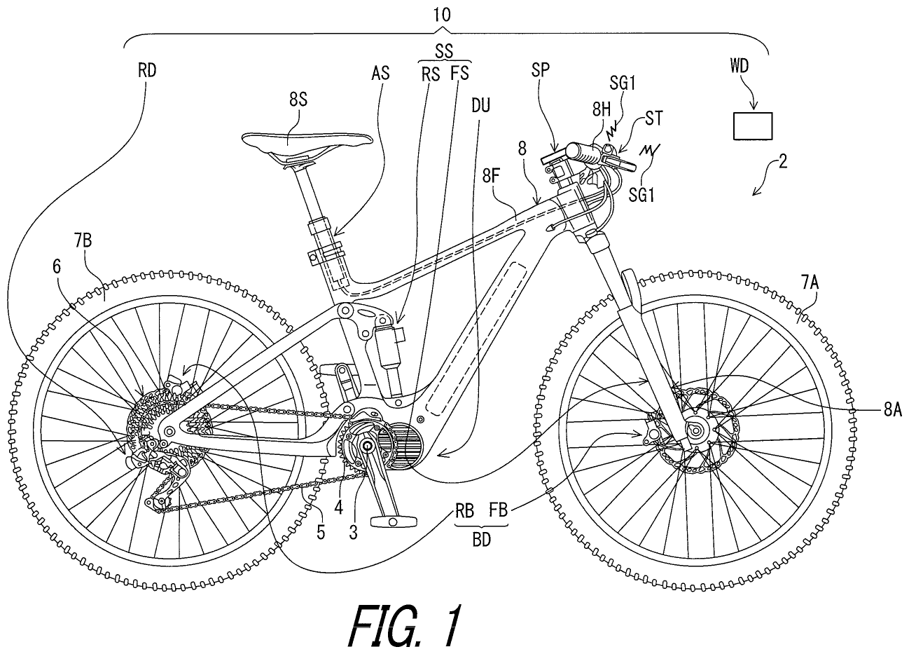

As seen in FIG. 1, a human-powered vehicle 2 includes a control system 10. The human-powered vehicle 2 includes a crank 3, a sprocket 4, a chain 5, a sprocket assembly 6, a wheel 7A, a wheel 7B, and a vehicle body 8. The vehicle body 8 includes, for example, a frame 8F, a handlebar 8H, a front fork 8A, and a saddle 8S. The crank 3 is rotatably coupled to the vehicle body 8. The crank 3 is rotatable relative to the vehicle body 8 during pedaling. The sprocket 4 is coupled to the crank 3. The sprocket assembly 6 is rotatably coupled to the vehicle body 8. The chain 5 is engaged with the sprocket 4 and the sprocket assembly 6. The sprocket assembly 6 is coupled to the wheel 7A to transmit a pedaling force from the crank 3 to the wheel 7A via the sprocket 4 and the chain 5. The sprocket 4 can include at least two sprockets if needed or desired.

In the present application, the term “human-powered vehicle” includes a vehicle to travel with a motive power including at least a human power of a user (i.e., rider) who rides the vehicle. The human-powered vehicle includes a various kind of bicycles such as a mountain bike, a road bike, a city bike, a cargo bike, a hand bike, and a recumbent bike. Furthermore, the human-powered vehicle includes an electric bike (E-bike). The electric bike includes an electrically assisted bicycle configured to assist propulsion of a vehicle with an electric motor. However, a total number of wheels of the human-powered vehicle is not limited to two. For example, the human-powered vehicle includes a vehicle having one wheel or three or more wheels. Especially, the human-powered vehicle does not include a vehicle that uses only a driving source (e.g., an internal-combustion engine, an electric motor) as motive power. Generally, a light road vehicle, which includes a vehicle that does not require a driver's license for a public road, is assumed as the human-powered vehicle.

As seen in FIG. 1, the human-powered vehicle 2 includes a gear changer RD. The gear changer RD is configured to be mounted to the vehicle body 8 of the human-powered vehicle 2. The gear changer RD is configured to change a gear ratio of the human-powered vehicle 2. The gear ratio is a ratio of a rotational speed of the sprocket assembly 6 to a rotational speed of the sprocket 4. The gear changer RD is configured to shift the chain 5 relative to the sprocket assembly 6. In the present embodiment, the gear changer RD includes a rear derailleur. However, the gear changer RD can include another type of gear changer if needed or desired. Examples of another type of gear changer include a front derailleur and an internal-gear hub.

The human-powered vehicle 2 includes a suspension SS. The suspension SS is configured to be mounted to the vehicle body 8 of the human-powered vehicle 2. The suspension SS is configured to absorb shocks or vibrations generated by riding on rough terrain. The suspension SS is configured to absorb shocks or vibrations transmitted from the wheel 7A and/or 7B. The suspension SS includes a suspension FS and a suspension RS. However, one of the suspensions FS and RS can be omitted from the suspension SS if needed or desired.

The human-powered vehicle 2 includes an assist drive unit DU. The assist drive unit DU is configured to be mounted to the vehicle body 8 of the human-powered vehicle 2. The assist drive unit DU is configured to assist propulsion of the human-powered vehicle 2. The assist drive unit DU is configured to change an assist ratio depending on a human power applied to the human-powered vehicle 2.

The human-powered vehicle 2 includes a brake device BD. The brake device BD is configured to be mounted to the vehicle body 8 of the human-powered vehicle 2. The brake device BD is configured to apply a braking force to the human-powered vehicle 2. The brake device BD includes a brake device FB and a brake device RB. The brake device FB is configured to apply a braking force to the wheel 7A. The brake device RB is configured to apply a braking force to the wheel 7B. One of the brake devices FB and RB can be omitted from the brake device BD if needed or desired.

The human-powered vehicle 2 includes an adjustable seatpost AS. The adjustable seatpost AS is configured to be mounted to the vehicle body 8 of the human-powered vehicle 2. The adjustable seatpost AS includes an adjustable seatpost. The adjustable seatpost AS is configured to change a height of the saddle 8S relative to the frame 8F. The adjustable seatpost AS has an adjustable state and a locked state. The adjustable seatpost AS allows the user to change the height of the saddle 8S in the adjustable state. The adjustable seatpost AS is locked to maintain the height of the saddle 8S in the locked state. The adjustable seatpost AS is configured to change the state of the adjustable seatpost AS between the adjustable state and the locked state.

The human-powered vehicle 2 includes a display device SP. The display device SP is configured to be mounted to the vehicle body 8 of the human-powered vehicle 2. The display device SP includes at least one of a smartphone and a cycle computer. The display device SP is configured to display information relating to the human-powered vehicle 2. However, the display device SP can include structures other than the smartphone and the cycle computer if needed or desired. The display device SP can also be referred to as an external device SP or a display device SP.

The human-powered vehicle 2 includes a wearable device WD. The wearable device WD is configured to be attached to the user such as the rider. The wearable device WD is configured to be attached to the user's body. The wearable device WD is configured to obtain information relating to the user. Examples of the wearable device WD includes a watch, a bracelet, a ring, a necklace, a belt, a helmet, a belt, and a device attachable to these items.

The human-powered vehicle 2 includes an operating device ST. The operating device ST is configured to be mounted to the vehicle body 8 of the human-powered vehicle 2. The operating device ST is configured to operate at least one of the adjustable seatpost AS, the gear changer RD, the suspension SS, the brake device BD, the assist drive unit DU, the display device SP, and the wearable device WD. The operating device ST is configured to be electrically connected to at least one of the adjustable seatpost AS, the gear changer RD, the suspension SS, the brake device BD, the assist drive unit DU, and the wearable device WD. The operating device ST is configured to receive at least one user input. The operating device ST is configured to generate at least one operating signal SG1 in response to the at least one user input. The operating device ST is configured to transmit the at least one operating signal SG1 wirelessly or via an electric cable to at least one of the adjustable seatpost AS, the gear changer RD, the suspension SS, the brake device BD, the assist drive unit DU, and the wearable device WD. The operating device ST can include at least two separate operating devices if needed or desired. At least one of the adjustable seatpost AS, the gear changer RD, the suspension SS, the brake device BD, the assist drive unit DU, and the wearable device WD is configured to operate in response to the at least one operating signal SG1.

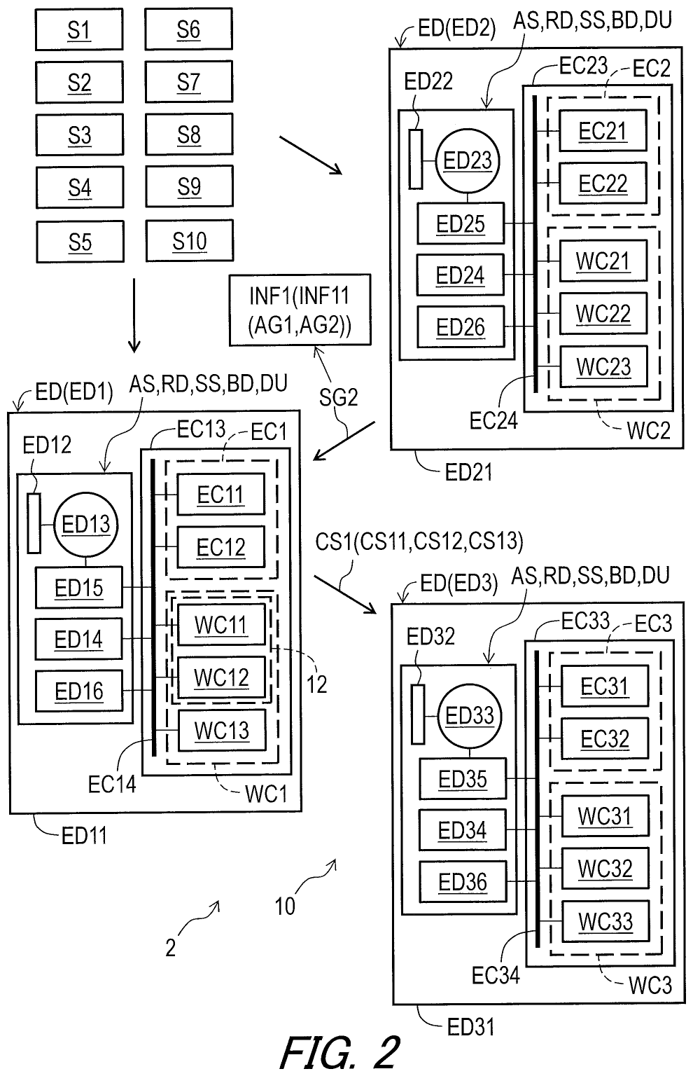

As seen in FIG. 2, the control system 10 includes a device ED. The device ED includes at least one of an electric device ED1, a second electric device ED2, and an additional electric device ED3. Namely, the control system 10 of the human-powered vehicle 2 comprises the electric device ED1. The control system 10 for the human-powered vehicle 2 comprises the second electric device ED2. The control system 10 for the human-powered vehicle 2 comprises the additional electric device ED3.

As seen in FIGS. 2 to 5, the electric device ED1 further comprises one of the operating device ST, the adjustable seatpost AS, the gear changer RD, the suspension SS, the brake device BD, the assist drive unit DU, and the wearable device WD. The second electric device ED2 includes another of the operating device ST, the adjustable seatpost AS, the gear changer RD, the suspension SS, the brake device BD, the assist drive unit DU, and the wearable device WD. The additional electric device ED3 includes one of the adjustable seatpost AS, the gear changer RD, the suspension SS, the brake device BD, and the assist drive unit DU.

However, the electric device ED1 can include a device other than the operating device ST, the adjustable seatpost AS, the gear changer RD, the suspension SS, the brake device BD, the assist drive unit DU, and the wearable device WD if needed or desired. The additional electric device ED3 can include a device other than the operating device ST, the adjustable seatpost AS, the gear changer RD, the suspension SS, the brake device BD, the assist drive unit DU, and the wearable device WD if needed or desired. The additional electric device ED3 can be the same device as the second electric device ED2 if needed or desired.

In the present application, the following directional terms “front,” “rear,” “forward,” “rearward,” “left,” “right,” “transverse,” “upward” and “downward” as well as any other similar directional terms refer to those directions which are determined based on the user who is in the user's standard position in the human-powered vehicle 2 while the user faces toward a handlebar or steering. Examples of the user's standard position include a saddle and a seat. Accordingly, these terms, as utilized to describe the operating device ST, the adjustable seatpost AS, the gear changer RD, the suspension SS, the brake device BD, the assist drive unit DU, and the wearable device WD or other devices, should be interpreted relative to the human-powered vehicle 2 equipped with the operating device ST, the adjustable seatpost AS, the gear changer RD, the suspension SS, the brake device BD, the assist drive unit DU, and the wearable device WD or other devices as used in an upright riding position on a horizontal surface.

As seen in FIG. 2, the electric device ED1 of the human-powered vehicle 2 comprises first wireless communicator circuitry WC1 and electronic controller circuitry EC1. The second electric device ED2 includes second wireless communicator circuitry WC2. The additional electric device ED3 includes additional wireless communicator circuitry WC3.

The first wireless communicator circuitry WC1 is configured to wirelessly communicate with the second wireless communicator circuitry WC2 of the second electric device ED2. The first wireless communicator circuitry WC1 is configured to wirelessly communicate with the additional wireless communicator circuitry WC3 of the additional electric device ED3. The second wireless communicator circuitry WC2 is configured to wirelessly communicate with the first wireless communicator circuitry WC1 of the electric device ED1. The second wireless communicator circuitry WC2 is configured to wirelessly communicate with the additional wireless communicator circuitry WC3 of the additional electric device ED3. The additional wireless communicator circuitry WC3 is configured to wirelessly communicate with the first wireless communicator circuitry WC1 of the electric device ED1. The additional wireless communicator circuitry WC3 is configured to wirelessly communicate with the second wireless communicator circuitry WC2 of the second electric device ED2.

The term “wireless communicator” or “wireless communicator circuitry” as used herein includes a receiver, a transmitter, a transceiver, a transmitter-receiver, and contemplates any device or devices, separate or combined, capable of transmitting and/or receiving wireless communication signals, including shift signals or control, command or other signals related to some function of the component being controlled. Here, at least one of the first wireless communicator circuitry WC1, the second wireless communicator circuitry WC2, and the additional wireless communicator circuitry WC3 is configured to at least receive a wireless signal. For example, each of the first wireless communicator circuitry WC1, the second wireless communicator circuitry WC2, and the additional wireless communicator circuitry WC3 includes a two-way wireless transceiver that conducts two-way wireless communications using the wireless receiver for wirelessly receiving signals and a wireless transmitter for wirelessly transmitting signals.

Each of the first wireless communicator circuitry WC1, the second wireless communicator circuitry WC2, and the additional wireless communicator circuitry WC3 can use radio frequency (RF) signals, ultra-wide band communication signals, radio frequency identification (RFID), Wi-Fi (registered trademark), Zigbee (registered trademark), ANT+ (registered trademark), or Bluetooth (registered trademark) or any other type of communication protocols suitable for short range wireless communications as understood in the human-powered vehicle field.

It should also be understood that each of the first wireless communicator circuitry WC1, the second wireless communicator circuitry WC2, and the additional wireless communicator circuitry WC3 can transmit the signals at a particular or randomly selected frequency and/or with an identifier such as a particular code, to distinguish the wireless signal from other wireless signals. In this way, each of the electric device ED1, the second electric device ED2, and the additional electric device ED3 can recognize which signals are to be acted upon and which signals are not to be acted upon. Thus, each of the electric device ED1, the second electric device ED2, and the additional electric device ED3 can ignore the signals from other wireless communicators of other electric devices.

The first wireless communicator circuitry WC1 is configured to be paired with each of the second wireless communicator circuitry WC2 and the additional wireless communicator circuitry WC3. The second wireless communicator circuitry WC1 is configured to be paired with each of the first wireless communicator circuitry WC1 and the additional wireless communicator circuitry WC3. The additional wireless communicator circuitry WC3 is configured to be paired with the first wireless communicator circuitry WC1 and the second wireless communicator circuitry WC2.

As seen in FIG. 2, the electric device ED1 of the human-powered vehicle 2 comprises electronic controller circuitry EC1. Namely, the control system 10 for the human-powered vehicle 2 comprises the electronic controller circuitry EC1. The electronic controller circuitry EC1 is electrically connected to the first wireless communicator circuitry WC1.

The electronic controller circuitry EC1 includes a processor EC11 and a memory EC12. The electric device ED1 includes a substrate EC13 and a system bus EC14. The processor EC11 is coupled to the memory EC12. The memory EC12 is coupled to the processor EC11. The processor EC11 and the memory EC12 are electrically mounted on the substrate EC13. The processor EC11 is electrically connected to the memory EC12 via the substrate EC13 and the system bus EC14. The memory EC12 is electrically connected to the processor EC11 via the substrate EC13 and the system bus EC14. For example, the electronic controller circuitry EC1 includes a semiconductor. The processor EC11 includes a semiconductor. The memory EC12 includes a semiconductor. However, the electronic controller circuitry EC1 can be free of a semiconductor if needed or desired. The processor EC11 can be free of a semiconductor if needed or desired. The memory EC12 can be free of a semiconductor if needed or desired.

For example, the processor EC11 includes at least one of a central processing unit (CPU), a micro processing unit (MPU), and a memory controller. The memory EC12 is electrically connected to the processor EC11. For example, the memory EC12 includes at least one of a volatile memory and a non-volatile memory. Examples of the volatile memory include a random-access memory (RAM) and a dynamic random-access memory (DRAM). Examples of the non-volatile memory include a read only memory (ROM), an electrically erasable programmable ROM (EEPROM), and a magnetic disc. The memory

EC12 includes storage areas each having an address. The processor EC11 is configured to control the memory EC12 to store data in the storage areas of the memory EC12 and reads data from the storage areas of the memory EC12. The processor EC11 can also be referred to as a hardware processor EC11 or a processor circuit or circuitry EC11. The memory EC12 can also be referred to as a hardware memory EC12 or a memory circuit or circuitry EC12. The memory EC12 can also be referred to as a non-transitory computer-readable storage medium EC12. Namely, the electronic controller circuitry EC1 includes the non-transitory computer-readable storage medium EC12.

The electronic controller circuitry EC1 is configured to execute at least one control algorithm of the electric device ED1. For example, the electronic controller circuitry EC1 is programed to execute at least one control algorithm of the electric device ED1. The memory EC12 stores at least one program including at least one program instruction. The at least one program is read into the processor EC11, and thereby the at least one control algorithm of the electric device ED1 is executed based on the at least one program.

The structure of the electronic controller circuitry EC1 is not limited to the above structure. The structure of the electronic controller circuitry EC1 is not limited to the processor EC11 and the memory EC12. The electronic controller circuitry EC1 can be realized by hardware alone or a combination of hardware and software. In the present embodiment, the processor EC11 and the memory EC12 are integrated as a single chip such as an application specific integrated circuit (ASIC) or a field programmable gate array (FPGA). However, the processor EC11 and the memory EC12 can be separate chips if needed or desired. The electronic controller circuitry EC1 can include the processor EC11, the memory EC12, the substrate EC13, and the system bus EC14 if needed or desired. The electronic controller circuitry EC1 can be at least two electronic controllers which are separately provided.

The electronic controller circuitry EC1 can include at least two electronic controllers which are separately provided. The at least one control algorithm of the electric device ED1 can be executed by the at least two electronic controllers if needed or desired. The electronic controller circuitry EC1 can include at least two hardware processors which are separately provided. The electronic controller circuitry EC1 can include at least two hardware memories which are separately provided. The at least one control algorithm of the electric device ED1 can be executed by the at least two hardware processors if needed or desired. The at least one control algorithm of the electric device ED1 can be stored in the at least two hardware memories if needed or desired. The electronic controller circuitry EC1 can include at least two circuit boards which are separately provided if needed or desired. The electronic controller circuitry EC1 can include at least two system buses which are separately provided if needed or desired.

The first wireless communicator circuitry WC1 is electrically mounted on the circuit board EC13. The first wireless communicator circuitry WC1 is electrically connected to the processor EC11 and the memory EC12 with the circuit board EC13 and the system bus EC14. For example, the first wireless communicator circuitry WC1 includes first signal transmitting circuitry WC11, first signal receiving circuitry WC12, and first antenna circuitry WC13. The first signal transmitting circuitry WC11 is electrically connected to the first antenna circuitry WC13. The first signal receiving circuitry WC12 is electrically connected to the first antenna circuitry WC13.

The first wireless communicator circuitry WC1 is configured to transmit wireless signals via the first antenna circuitry WC13. The first wireless communicator circuitry WC1 is configured to superimpose digital signals on carrier wave using a predetermined wireless communication protocol to wirelessly transmit signals. In the present embodiment, the first wireless communicator circuitry WC1 is configured to encrypt signals using a cryptographic key to generate encrypted wireless signals.

The first wireless communicator circuitry WC1 is configured to receive wireless signals via the first antenna circuitry WC13. In the present embodiment, the first wireless communicator circuitry WC1 is configured to decode the wireless signals to recognize signals transmitted from other wireless communicators. The first wireless communicator circuitry WC1 is configured to decrypt the wireless signals using the cryptographic key.

As seen in FIG. 2, the second electric device ED2 of the human-powered vehicle 2 comprises second electronic controller circuitry EC2. Namely, the control system 10 for the human-powered vehicle 2 comprises the second electronic controller circuitry EC2. The second electronic controller circuitry EC2 is electrically connected to the second wireless communicator circuitry WC2.

The second electronic controller circuitry EC2 includes a processor EC21 and a memory EC22. The second electric device ED2 includes a substrate EC23 and a system bus EC24. The processor EC21 is coupled to the memory EC22. The memory EC22 is coupled to the processor EC21. The processor EC21 and the memory EC22 are electrically mounted on the substrate EC23. The processor EC21 is electrically connected to the memory EC22 via the substrate EC23 and the system bus EC24. The memory EC22 is electrically connected to the processor EC21 via the substrate EC23 and the system bus EC24. For example, the second electronic controller circuitry EC2 includes a semiconductor. The processor EC21 includes a semiconductor. The memory EC22 includes a semiconductor. However, the second electronic controller circuitry EC2 can be free of a semiconductor if needed or desired. The processor EC21 can be free of a semiconductor if needed or desired. The memory EC22 can be free of a semiconductor if needed or desired.

For example, the processor EC21 includes at least one of a central processing unit (CPU), a micro processing unit (MPU), and a memory controller. The memory EC22 is electrically connected to the processor EC21. For example, the memory EC22 includes at least one of a volatile memory and a non-volatile memory. Examples of the volatile memory include a random-access memory (RAM) and a dynamic random-access memory (DRAM). Examples of the non-volatile memory include a read only memory (ROM), an electrically erasable programmable ROM (EEPROM), and a magnetic disc. The memory EC22 includes storage areas each having an address. The processor EC21 is configured to control the memory EC22 to store data in the storage areas of the memory EC22 and reads data from the storage areas of the memory EC22. The processor EC21 can also be referred to as a hardware processor EC21 or a processor circuit or circuitry EC21. The memory EC22 can also be referred to as a hardware memory EC22 or a memory circuit or circuitry EC22. The memory EC22 can also be referred to as a non-transitory computer-readable storage medium EC22. Namely, the second electronic controller circuitry EC2 includes the non-transitory computer-readable storage medium EC22.

The second electronic controller circuitry EC2 is configured to execute at least one control algorithm of the second electric device ED2. For example, the second electronic controller circuitry EC2 is programed to execute at least one control algorithm of the second electric device ED2. The memory EC22 stores at least one program including at least one program instruction. The at least one program is read into the processor EC21, and thereby the at least one control algorithm of the second electric device ED2 is executed based on the at least one program.

The structure of the second electronic controller circuitry EC2 is not limited to the above structure. The structure of the second electronic controller circuitry EC2 is not limited to the processor EC21 and the memory EC22. The second electronic controller circuitry EC2 can be realized by hardware alone or a combination of hardware and software. In the present embodiment, the processor EC21 and the memory EC22 are integrated as a single chip such as an application specific integrated circuit (ASIC) or a field programmable gate array (FPGA). However, the processor EC21 and the memory EC22 can be separate chips if needed or desired. The second electronic controller circuitry EC2 can include the processor EC21, the memory EC22, the substrate EC23, and the system bus EC24 if needed or desired. The second electronic controller circuitry EC2 can be at least two second electronic controllers which are separately provided.

The second electronic controller circuitry EC2 can include at least two second electronic controllers which are separately provided. The at least one control algorithm of the second electric device ED2 can be executed by the at least two second electronic controllers if needed or desired. The second electronic controller circuitry EC2 can include at least two hardware processors which are separately provided. The second electronic controller circuitry EC2 can include at least two hardware memories which are separately provided. The at least one control algorithm of the second electric device ED2 can be executed by the at least two hardware processors if needed or desired. The at least one control algorithm of the second electric device ED2 can be stored in the at least two hardware memories if needed or desired. The second electronic controller circuitry EC2 can include at least two circuit boards which are separately provided if needed or desired. The second electronic controller circuitry EC2 can include at least two system buses which are separately provided if needed or desired.

The second wireless communicator circuitry WC2 is electrically mounted on the circuit board EC23. The second wireless communicator circuitry WC2 is electrically connected to the processor EC21 and the memory EC22 with the circuit board EC23 and the system bus EC24. For example, the second wireless communicator circuitry WC2 includes second signal transmitting circuitry WC21, second signal receiving circuitry WC22, and second antenna circuitry WC23. The second signal transmitting circuitry WC21 is electrically connected to the second antenna circuitry WC23. The second signal receiving circuitry WC22 is electrically connected to the second antenna circuitry WC23.

The second wireless communicator circuitry WC2 is configured to transmit wireless signals via the second antenna circuitry WC23. The second wireless communicator circuitry WC2 is configured to superimpose digital signals on carrier wave using a predetermined wireless communication protocol to wirelessly transmit signals. In the present embodiment, the second wireless communicator circuitry WC2 is configured to encrypt signals using a cryptographic key to generate encrypted wireless signals.

The second wireless communicator circuitry WC2 is configured to receive wireless signals via the second antenna circuitry WC23. In the present embodiment, the second wireless communicator circuitry WC2 is configured to decode the wireless signals to recognize signals transmitted from other wireless communicators. The second wireless communicator circuitry WC2 is configured to decrypt the wireless signals using the cryptographic key.

As seen in FIG. 2, the additional electric device ED3 of the human-powered vehicle 2 comprises additional electronic controller circuitry EC3. Namely, the control system 10 for the human-powered vehicle 2 comprises the additional electronic controller circuitry EC3. The additional electronic controller circuitry EC3 is electrically connected to the additional wireless communicator circuitry WC3.

The additional electronic controller circuitry EC3 includes a processor EC31 and a memory EC32. The additional electric device ED3 includes a substrate EC33 and a system bus EC34. The processor EC31 is coupled to the memory EC32. The memory EC32 is coupled to the processor EC31. The processor EC31 and the memory EC32 are electrically mounted on the substrate EC33. The processor EC31 is electrically connected to the memory EC32 via the substrate EC33 and the system bus EC34. The memory EC32 is electrically connected to the processor EC31 via the substrate EC33 and the system bus EC34. For example, the additional electronic controller circuitry EC3 includes a semiconductor. The processor EC31 includes a semiconductor. The memory EC32 includes a semiconductor. However, the additional electronic controller circuitry EC3 can be free of a semiconductor if needed or desired. The processor EC31 can be free of a semiconductor if needed or desired. The memory EC32 can be free of a semiconductor if needed or desired.

For example, the processor EC31 includes at least one of a central processing unit (CPU), a micro processing unit (MPU), and a memory controller. The memory EC32 is electrically connected to the processor EC31. For example, the memory EC32 includes at least one of a volatile memory and a non-volatile memory. Examples of the volatile memory include a random-access memory (RAM) and a dynamic random-access memory (DRAM). Examples of the non-volatile memory include a read only memory (ROM), an electrically erasable programmable ROM (EEPROM), and a magnetic disc. The memory EC32 includes storage areas each having an address. The processor EC31 is configured to control the memory EC32 to store data in the storage areas of the memory EC32 and reads data from the storage areas of the memory EC32. The processor EC31 can also be referred to as a hardware processor EC31 or a processor circuit or circuitry EC31. The memory EC32 can also be referred to as a hardware memory EC32 or a memory circuit or circuitry EC32. The memory EC32 can also be referred to as a non-transitory computer-readable storage medium EC32. Namely, the additional electronic controller circuitry EC3 includes the non-transitory computer-readable storage medium EC32.

The additional electronic controller circuitry EC3 is configured to execute at least one control algorithm of the additional electric device ED3. For example, the additional electronic controller circuitry EC3 is programed to execute at least one control algorithm of the additional electric device ED3. The memory EC32 stores at least one program including at least one program instruction. The at least one program is read into the processor EC31, and thereby the at least one control algorithm of the additional electric device ED3 is executed based on the at least one program.

The structure of the additional electronic controller circuitry EC3 is not limited to the above structure. The structure of the additional electronic controller circuitry EC3 is not limited to the processor EC31 and the memory EC32. The additional electronic controller circuitry EC3 can be realized by hardware alone or a combination of hardware and software. In the present embodiment, the processor EC31 and the memory EC32 are integrated as a single chip such as an application specific integrated circuit (ASIC) or a field programmable gate array (FPGA). However, the processor EC31 and the memory EC32 can be separate chips if needed or desired. The additional electronic controller circuitry EC3 can include the processor EC31, the memory EC32, the substrate EC33, and the system bus EC34 if needed or desired. The additional electronic controller circuitry EC3 can be at least two additional electronic controllers which are separately provided.

The additional electronic controller circuitry EC3 can include at least two additional electronic controllers which are separately provided. The at least one control algorithm of the additional electric device ED3 can be executed by the at least two additional electronic controllers if needed or desired. The additional electronic controller circuitry EC3 can include at least two hardware processors which are separately provided. The additional electronic controller circuitry EC3 can include at least two hardware memories which are separately provided. The at least one control algorithm of the additional electric device ED3 can be executed by the at least two hardware processors if needed or desired. The at least one control algorithm of the additional electric device ED3 can be stored in the at least two hardware memories if needed or desired. The additional electronic controller circuitry EC3 can include at least two circuit boards which are separately provided if needed or desired. The additional electronic controller circuitry EC3 can include at least two system buses which are separately provided if needed or desired.

The additional wireless communicator circuitry WC3 is electrically mounted on the circuit board EC33. The additional wireless communicator circuitry WC3 is electrically connected to the processor EC31 and the memory EC32 with the circuit board EC33 and the system bus EC34. For example, the additional wireless communicator circuitry WC3 includes additional signal transmitting circuitry WC31, additional signal receiving circuitry WC32, and additional antenna circuitry WC33. The additional signal transmitting circuitry WC31 is electrically connected to the additional antenna circuitry WC33. The additional signal receiving circuitry WC32 is electrically connected to the additional antenna circuitry WC33.

The additional wireless communicator circuitry WC3 is configured to transmit wireless signals via the additional antenna circuitry WC33. The additional wireless communicator circuitry WC3 is configured to superimpose digital signals on carrier wave using a predetermined wireless communication protocol to wirelessly transmit signals. In the present embodiment, the additional wireless communicator circuitry WC3 is configured to encrypt signals using a cryptographic key to generate encrypted wireless signals.

The additional wireless communicator circuitry WC3 is configured to receive wireless signals via the additional antenna circuitry WC33. In the present embodiment, the additional wireless communicator circuitry WC3 is configured to decode the wireless signals to recognize signals transmitted from other wireless communicators. The additional wireless communicator circuitry WC3 is configured to decrypt the wireless signals using the cryptographic key.

As seen in FIG. 2, in a case where the electric device ED1 includes one of the adjustable seatpost AS, the gear changer RD, the suspension SS, the brake device BD, and the assist drive unit DU, the electric device ED1 includes a base member ED11, a movable member ED12, and an electric actuator ED13. The base member ED11 is configured to be mounted to the vehicle body 8 (see e.g., FIG. 1). The movable member ED12 is movably coupled to the base member ED11. The movable member ED12 is configured to guide the chain 5 (see e.g., FIG. 1). The electric actuator ED13 is configured to move the movable member ED12 relative to the base member ED11.

The electric device ED1 includes a position sensor ED14 and an actuator driver ED15. The electric actuator ED13 is electrically connected to the position sensor ED14 and the actuator driver ED15. The electric actuator ED13 includes a rotational shaft operatively coupled to the movable member ED12. The position sensor ED14 is configured to sense a current position of the movable member ED12 relative to the base member ED11.

Examples of the position sensor ED14 include a potentiometer, a magnetic sensor, and a rotary encoder. The position sensor ED14 is configured to sense a rotational position of an output shaft of the electric actuator ED13 as the current position of the movable member ED12 relative to the base member ED11. The actuator driver ED15 is configured to control the electric actuator ED13 based on the current position of the movable member ED12 relative to the base member ED11 sensed by the position sensor ED14.

The electric device ED1 includes an electric power source ED16. The electric power source ED16 is electrically connected to the electric actuator ED13, the position sensor ED14, and the actuator driver ED15 to supply electricity to the electric actuator ED13, the position sensor ED14, and the actuator driver ED15. Examples of the electric power source ED16 include a primary battery and a secondary battery. The electric device ED1 can be configured to be powered by an external electric power source electrically connected to the electric device ED1 via an electric cable.

As seen in FIG. 2, in a case where the second electric device ED2 includes one of the adjustable seatpost AS, the gear changer RD, the suspension SS, the brake device BD, and the assist drive unit DU, the second electric device ED2 includes a second base member ED21, a second movable member ED22, and a second electric actuator ED23. The second base member ED21 is configured to be mounted to the vehicle body 8 (see e.g., FIG. 1). The second movable member ED22 is movably coupled to the second base member ED21. The second movable member ED22 is configured to guide the chain 5 (see e.g., FIG. 1). The second electric actuator ED23 is configured to move the second movable member ED22 relative to the second base member ED21.

The second electric device ED2 includes a second position sensor ED24 and a second actuator driver ED25. The second electric actuator ED23 is electrically connected to the second position sensor ED24 and the second actuator driver ED25. The second electric actuator ED23 includes a rotational shaft operatively coupled to the second movable member ED22. The second position sensor ED24 is configured to sense a current position of the second movable member ED22 relative to the second base member ED21. Examples of the second position sensor ED24 include a potentiometer, a magnetic sensor, and a rotary encoder. The second position sensor ED24 is configured to sense a rotational position of an output shaft of the second electric actuator ED23 as the current position of the second movable member ED22 relative to the second base member ED21. The second actuator driver ED25 is configured to control the second electric actuator ED23 based on the current position of the second movable member ED22 relative to the second base member ED21 sensed by the second position sensor ED24.

The second electric device ED2 includes a second electric power source ED26. The second electric power source ED26 is electrically connected to the second electric actuator ED23, the second position sensor ED24, and the second actuator driver ED25 to supply electricity to the second electric actuator ED23, the second position sensor ED24, and the second actuator driver ED25. Examples of the second electric power source ED26 include a primary battery and a secondary battery. The second electric device ED2 can be configured to be powered by an external second electric power source electrically connected to the second electric device ED2 via an electric cable.

As seen in FIG. 2, in a case where the additional electric device ED3 includes one of the adjustable seatpost AS, the gear changer RD, the suspension SS, the brake device BD, and the assist drive unit DU, the additional electric device ED3 includes a third base member ED31, a third movable member ED32, and a third electric actuator ED33. The third base member ED31 is configured to be mounted to the vehicle body 8 (see e.g., FIG. 1). The third movable member ED32 is movably coupled to the third base member ED31. The third movable member ED32 is configured to guide the chain 5 (see e.g., FIG. 1). The third electric actuator ED33 is configured to move the third movable member ED32 relative to the third base member ED31.

The additional electric device ED3 includes a third position sensor ED34 and a third actuator driver ED35. The third electric actuator ED33 is electrically connected to the third position sensor ED34 and the third actuator driver ED35. The third electric actuator ED33 includes a rotational shaft operatively coupled to the third movable member ED32. The third position sensor ED34 is configured to sense a current position of the third movable member ED32 relative to the third base member ED31. Examples of the third position sensor ED34 include a potentiometer, a magnetic sensor, and a rotary encoder. The third position sensor ED34 is configured to sense a rotational position of an output shaft of the third electric actuator ED33 as the current position of the third movable member ED32 relative to the third base member ED31. The third actuator driver ED35 is configured to control the third electric actuator ED33 based on the current position of the third movable member ED32 relative to the third base member ED31 sensed by the third position sensor ED34.

The additional electric device ED3 includes a third electric power source ED36. The third electric power source ED36 is electrically connected to the third electric actuator ED33, the third position sensor ED34, and the third actuator driver ED35 to supply electricity to the third electric actuator ED33, the third position sensor ED34, and the third actuator driver ED35. Examples of the third electric power source ED36 include a primary battery and a secondary battery. The additional electric device ED3 can be configured to be powered by an external third electric power source electrically connected to the additional electric device ED3 via an electric cable.

In a case where one of the electric device ED1, the second electric device ED2, and the additional electric device ED3 includes the adjustable seatpost AS, the one of the electric device ED1, the second electric device ED2, and the additional electric device ED3 includes a state changing structure configured to change a state of the adjustable seatpost AS between at least two states. The movable member ED12, ED22, or ED32 includes at least part of the state changing structure. For example, the adjustable seatpost AS has a first state, a second state, and a third state. The adjustable seatpost AS has a first length in the first state. The adjustable seatpost AS has a second length in the second state. The adjustable seatpost AS has a third length in the third state. The first length is different from the second length and the third length. The second length is different from the third length. The electric actuator ED13, ED23, or ED33 is configured to move the movable member ED12, ED22, or ED32 to change the state of the adjustable seatpost AS between the first state, the second state, and the third state. A length of the adjustable seatpost AS can be adjustable in at least one of the first state, the second state, and the third state. The adjustable seatpost AS can be restricted from changing the length in another of the first state, the second state, and the third state.

In a case where one of the electric device ED1, the second electric device ED2, and the additional electric device ED3 includes the gear changer RD, the movable member ED12, ED22, or ED32 includes a chain guide. For example, the gear changer RD has at least two states. The gear changer RD has a first state, a second state, and a third state. The gear changer RD has a first gear position in the first state. The gear changer RD has a second gear position in the second state. The gear changer RD has a third gear position in the third state. The first gear position is different from the second gear position and the third gear position. The second gear position is different from the third gear position. The electric actuator ED13, ED23, or ED33 is configured to move the movable member ED12, ED22, or ED32 to change the state of the gear changer RD between the first state, the second state, and the third state.

In a case where one of the electric device ED1, the second electric device ED2, and the additional electric device ED3 includes the suspension SS, the one of the electric device ED1, the second electric device ED2, and the additional electric device ED3 includes a state changing structure configured to change a state of the suspension SS between at least two states. The movable member ED12, ED22, or ED32 includes at least part of the state changing structure. For example, the suspension SS has a first state, a second state, and a third state. The suspension SS is configured to absorb or damp shocks or vibrations within a first stroke in the first state. The suspension SS is configured to absorb or damp shocks or vibrations within a second stroke in the second state. The suspension SS is configured to absorb or damp shocks or vibrations within a third stroke in the third state. The first stroke is different from the second stroke and the third stroke. The second stroke is different from the third stroke. One of the first stroke, the second stroke, and the third stroke can be zero. The suspension SS is locked in a case where the stroke is zero. Furthermore, the suspension SS is configured to absorb or damp shocks or vibrations under first damping performance in the first state. The suspension SS is configured to absorb or damp shocks or vibrations under second damping performance in the second state. The suspension SS is configured to absorb or damp shocks or vibrations under third damping performance in the third state. The first damping performance is different from the second damping performance and the third damping performance. The first damping performance is different from the second damping performance. The electric actuator ED13, ED23, or ED33 is configured to move the movable member ED12, ED22, or ED32 to change the state of the suspension SS between the first state, the second state, and the third state.

In a case where one of the electric device ED1, the second electric device ED2, and the additional electric device ED3 includes the brake device BD, the movable member ED12, ED22, or ED32 includes a brake pad. For example, the brake device BD has a first state, a second state, and a third state. In the first state, the brake device BD is configured to apply a first braking force in response to an operating signal transmitted from the operating device ST. In the second state, the brake device BD is configured to apply a second braking force in response to the operating signal transmitted from the operating device ST. In the third state, the brake device BD is configured to apply a third braking force in response to the operating signal transmitted from the operating device ST. The first braking force is different from the second braking force and the third braking force. The second braking force is different from the third braking force. One of the first braking force, the second braking force, and the third braking force can be zero. Namely, in one of the first state, the second state, and the third state, the brake device BD is configured to restrict the brake device BD from generating a braking force in the case where the brake device BD receives the operating signal transmitted from the operating device ST.

In a case where one of the electric device ED1, the second electric device ED2, and the additional electric device ED3 includes the assist drive unit DU, the movable member ED12, ED22, or ED32 includes a sprocket configured to be engaged with the chain 5. For example, the assist drive unit DU has a first state, a second state, and a third state. The assist drive unit DU has a first assist ratio in the first state. The assist drive unit DU has a second assist ratio in the second state. The assist drive unit DU has a third assist ratio in the third state. The first assist ratio is different from the second assist ratio and the third assist ratio. The second assist ratio is different from the third assist ratio. One of the first assist ratio, the second assist ratio, and the third assist ratio is lower than another of the first assist ratio, the second assist ratio, and the third assist ratio. In the first state, the electric actuator ED13, ED23, or ED33 is configured to assist propulsion of the human-powered vehicle 2 based on the first assist ratio. In the second state, the electric actuator ED13, ED23, or ED33 is configured to assist propulsion of the human-powered vehicle 2 based on the second assist ratio. In the third state, the electric actuator ED13, ED23, or ED33 is configured to assist propulsion of the human-powered vehicle 2 based on the third assist ratio.

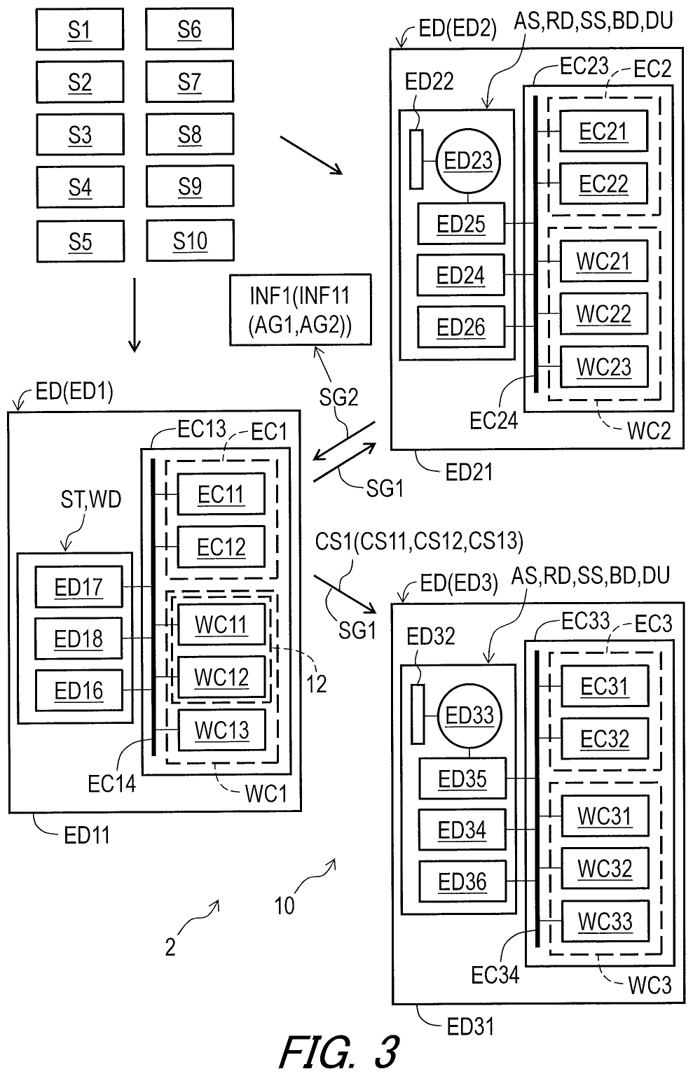

As seen in FIG. 3, in a case where the electric device ED1 includes the operating device ST, the electric device ED1 includes the base member ED11, the electric power source ED16, and a user interface ED17. In a case where the electric device ED1 includes the wearable device WD, the electric device ED1 includes the base member ED11, the electric power source ED16, and a wearable sensor ED18. The user interface ED17 is configured to receive a user input. Examples of the user interface ED17 includes an electric switch. The electronic controller circuitry EC1 is configured to control the first wireless communicator circuitry WC1 to wirelessly transmit an operating signal in response to the user input received by the user interface ED17. The wearable sensor ED18 is configured to obtain information relating to the rider.

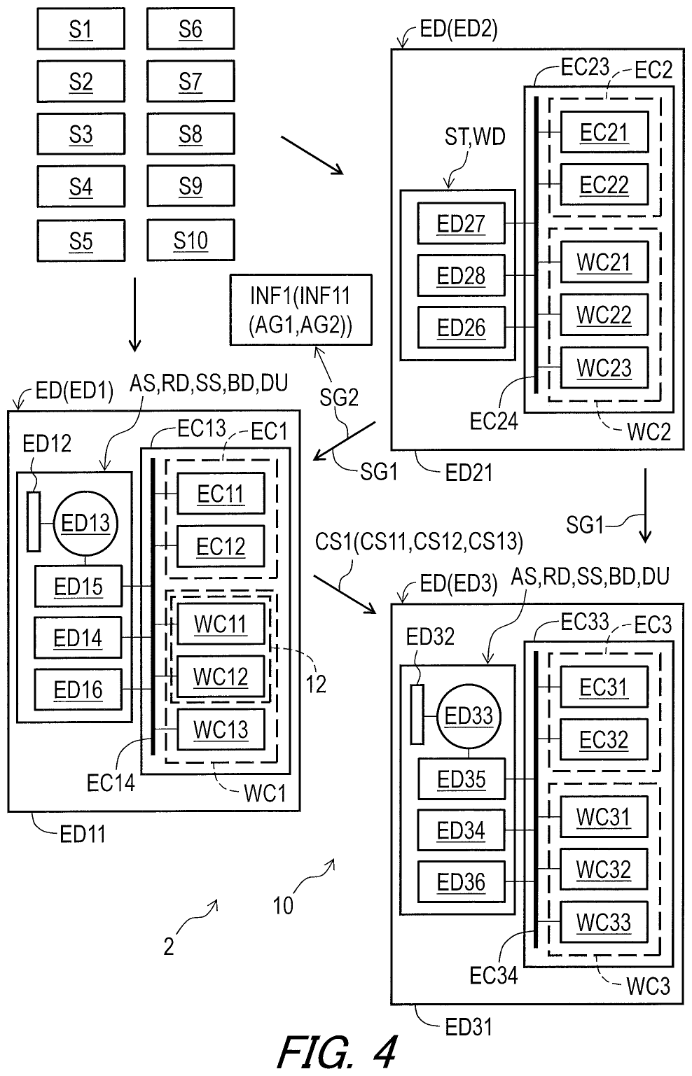

As seen in FIG. 4, in a case where the second electric device ED2 includes the operating device ST, the second electric device ED2 includes the second base member ED21, the second electric power source ED26, and a user interface ED27. In a case where the second electric device ED2 includes the wearable device WD, the second electric device ED2 includes the second base member ED21, the second electric power source ED26, and a wearable sensor ED28. The user interface ED27 is configured to receive a user input. Examples of the user interface ED27 includes an electric switch. The second electronic controller circuitry EC2 is configured to control the second wireless communicator circuitry WC2 to wirelessly transmit an operating signal in response to the user input received by the user interface ED27. The wearable sensor ED28 is configured to obtain information relating to the rider.

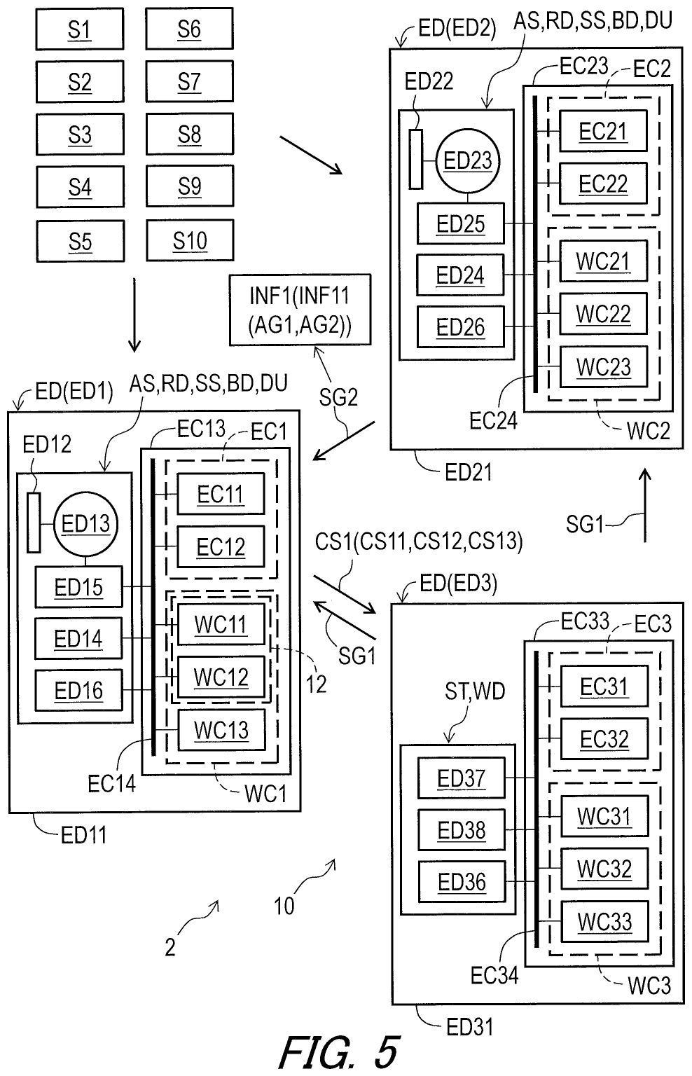

As seen in FIG. 5, in a case where the additional electric device ED3 includes the operating device ST, the additional electric device ED3 includes the third base member ED31, the third electric power source ED36, and a user interface ED37. In a case where the additional electric device ED3 includes the wearable device WD, the additional electric device ED3 includes the third base member ED31, the third electric power source ED36, and a wearable sensor ED38. The user interface ED37 is configured to receive a user input. Examples of the user interface ED37 includes an electric switch. The additional electronic controller circuitry EC3 is configured to control the additional wireless communicator circuitry WC3 to wirelessly transmit an operating signal in response to the user input received by the user interface ED37. The wearable sensor ED38 is configured to obtain information relating to the rider.

As seen in FIGS. 2 to 5, the electronic controller circuitry EC1 is configured to obtain information INF1 relating to a positional relationship between the first wireless communicator circuitry WC1 and the second wireless communicator circuitry WC2 so as to generate at least one control signal CS1 based on the information INF1. The additional electric device ED3 is configured to be controlled by at least one control signal CS1 generated by the electronic controller circuitry EC1.

One of the first wireless communicator circuitry WC1 and the second wireless communicator circuitry WC2 is movable relative to the other of the first wireless communicator circuitry WC1 and the second wireless communicator circuitry WC2. For example, one of the first wireless communicator circuitry WC1 and the second wireless communicator circuitry WC2 is at least partially provided to a movable part of the human-powered vehicle 2. The other of the first wireless communicator circuitry WC1 and the second wireless communicator circuitry WC2 is at least partially provided to a stationary part of the human-powered vehicle 2. For example, one of the first wireless communicator circuitry WC1 and the second wireless communicator circuitry WC2 is at least partially provided to the movable member ED12, ED22, or ED32. The other of the first wireless communicator circuitry WC1 and the second wireless communicator circuitry WC2 is at least partially provided to the base member ED11, ED21, or ED31. The positional relationship between the first wireless communicator circuitry WC1 and the second wireless communicator circuitry WC2 varies in response to the motion of the human-powered vehicle 2 and/or the rider of the human-powered vehicle 2.

The electronic controller circuitry EC1 is configured to generate the at least one control signal CS1 based on the information INF1. The electronic controller circuitry EC1 is configured to generate the at least one control signal CS1 based on the positional relationship or a change in the positional relationship. The first wireless communicator circuitry WC1 is configured to wirelessly transmit the at least one control signal CS1 to the additional electric device ED3. The electronic controller circuitry EC1 is configured to control the first wireless communicator circuitry WC1 to wirelessly transmit the at least one control signal CS1 to the additional electric device ED3 based on the information INF1.

The information INF1 includes directional information INF11 relating to a directional relationship between the first wireless communicator circuitry WC1 and the second wireless communicator circuitry WC2 in the human-powered vehicle 2. The electronic controller circuitry EC1 is configured to obtain the directional information INF11. The electronic controller circuitry EC1 is configured to generate the at least one control signal CS1 based on the directional information INF11.

For example, one of the first wireless communicator circuitry WC1 and the second wireless communicator circuitry WC2 is configured to wirelessly transmit a direction-finding signal SG2 at specific cycles. The other of the first wireless communicator circuitry WC1 and the second wireless communicator circuitry WC2 is configured to wirelessly receive the direction-finding signal SG2. The electronic controller circuitry EC1 is configured to obtain the directional information INF11 based on the direction-finding signal SG2.

In the present embodiment, the second wireless communicator circuitry WC2 is configured to wirelessly transmit the direction-finding signal SG2. The first wireless communicator circuitry WC1 is configured to wirelessly receive the direction-finding signal SG2. However, the second wireless communicator circuitry WC2 can be configured to wirelessly receive the direction-finding signal SG2 if needed or desired. The first wireless communicator circuitry WC1 can be configured to wirelessly receive the direction-finding signal SG2 if needed or desired.

The direction-finding signal SG2 includes direction-finding data. In a case where the first wireless communicator circuitry WC1 and the second wireless communicator circuitry WC2 use a protocol of Bluetooth (registered trademark), for example, the packet structure of the direction-finding signal SG2 includes preamble, access address, protocol data unit (PDU), cycle redundancy check (CRC), and constant tone extension (CTE). The CTE corresponds to the direction-finding data. The preamble is transmitted first, followed by the access address, the PDU, the CRC, and the CTE in this order. For example, the preamble, the access address, the PDU, and the CRC are transmitted at two frequencies and change the wavelength. However, the CTE is transmitted at one frequency and has a constant wavelength. Thus, it is possible to obtain directional information INF11 relating to a directional relationship between the first wireless communicator circuitry WC1 and the second wireless communicator circuitry WC2 in the human-powered vehicle 2. The first wireless communicator circuitry WC1 and the second wireless communicator circuitry WC2 can be configured to use a protocol other than Bluetooth (registered trademark) if needed or desired.

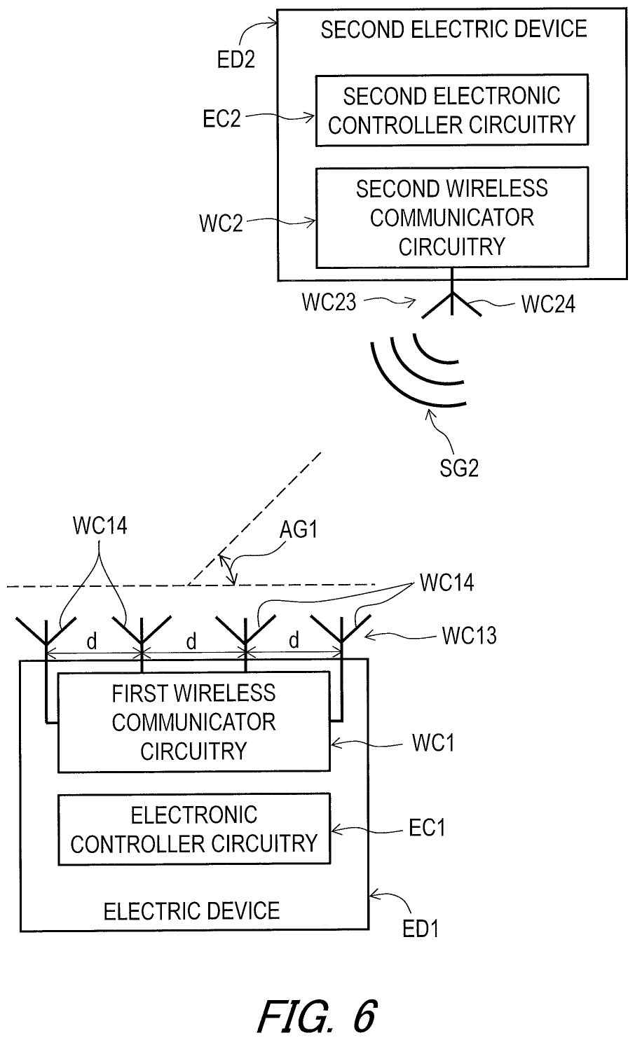

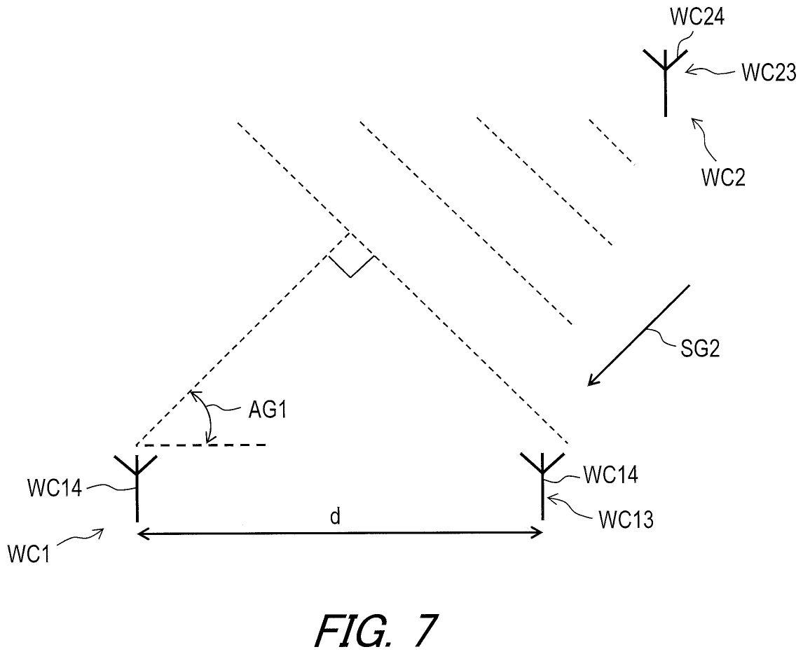

As seen in FIGS. 6 and 7, for example, the directional information INF11 can include an angle of arrival AG1. The angle of arrival AG1 is defined based on a relative position between the first wireless communicator circuitry WC1 and the second wireless communicator circuitry WC2. The electronic controller circuitry EC1 is configured to obtain the angle of arrival AG1.

For example, the first antenna circuitry WC13 includes at least two first antennas WC14. The second antenna circuitry WC23 includes a second antenna WC24. Namely, the first wireless communicator circuitry WC1 includes the at least two first antennas WC14. The second wireless communicator circuitry WC2 includes the second antenna WC24. The at least two first antennas WC14 are equally spaced.

The angle of arrival AG1 is defined based on a positional relationship between the at least two first antennas WC14 and the second antenna WC24 of the second wireless communicator circuitry WC2 in the human-powered vehicle 2.

A total number of the at least two first antennas WC14 is greater than or equal to three. However, the total number of the at least two first antennas WC14 can be equal to two if needed or desired. The total number of the at least two first antennas WC14 is not limited to the illustrated embodiment.

The electronic controller circuitry EC1 is configured to generate the at least one control signal CS1 based on the angle of arrival AG1. The electronic controller circuitry EC1 is configured to control the first wireless communicator circuitry WC1 to wirelessly transmit the at least one control signal CS1 based on the angle of arrival AG1.

For example, the electronic controller circuitry EC1 is configured to control the first wireless communicator circuitry WC1 to wirelessly transmit a first control signal CS11 in a case where the angle of arrival AG1 is greater than a first threshold TA1. The electronic controller circuitry EC1 is configured to control the first wireless communicator circuitry WC1 to wirelessly transmit a second control signal CS12 in a case where the angle of arrival AG1 is equal to or less than the first threshold TA1 and greater than a second threshold TA2. The electronic controller circuitry EC1 is configured to control the first wireless communicator circuitry WC1 to wirelessly transmit a third control signal CS13 in a case where the angle of arrival AG1 is equal to or less than the second threshold TA2. The electronic controller circuitry EC1 is configured to store the first threshold TA1 and the second threshold TA2 in the memory EC12.

The electronic controller circuitry EC1 is configured to calculate the angle of arrival AG1 based on the direction-finding signal SG2 wirelessly transmitted from the second wireless communicator circuitry WC2. The electronic controller circuitry EC1 is configured to obtain a phase difference (ψ) and a wave length (λ) based on the direction-finding signal SG2 received by the at least two first antennas WC14. The at least two first antennas WC14 are arranged at a distance (d) defined between adjacent two of the at least two first antennas WC14. Thus, the electronic controller circuitry EC1 is configured to calculate the angle of arrival AG1 based on the following formula (1). The electronic controller circuitry EC1 is configured to store the angle of arrival AG1 in the memory EC12 as the information INF1. The electronic controller circuitry EC1 is configured to store the angle of arrival AG1 in the memory EC12 as the directional information INF11.

$$A G 1 = arccos ( \frac{ψ λ}{2 π d} ) \qquad ( 1 )$$

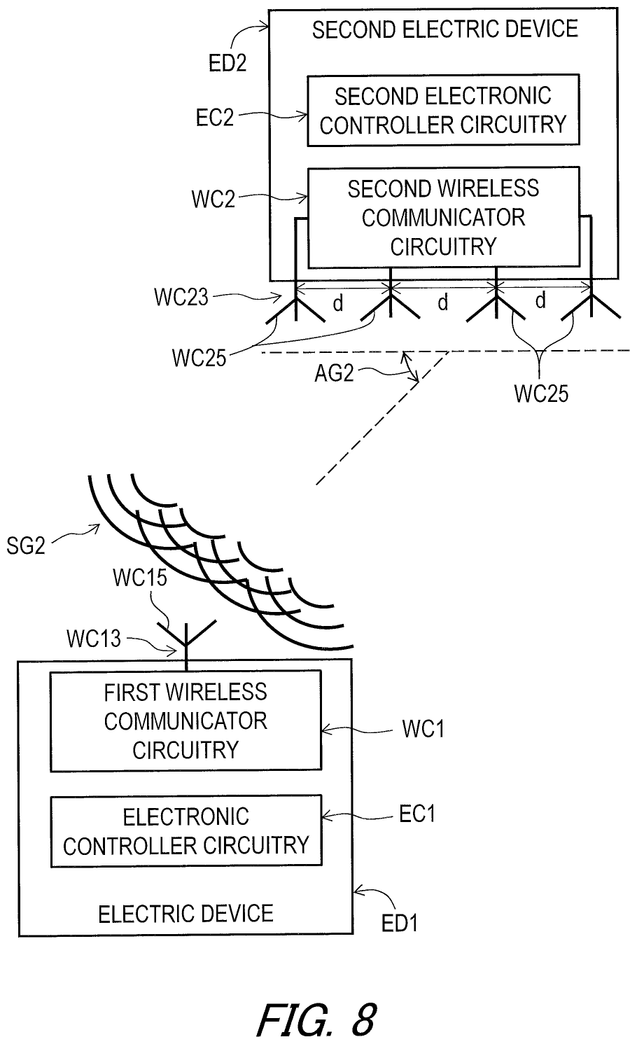

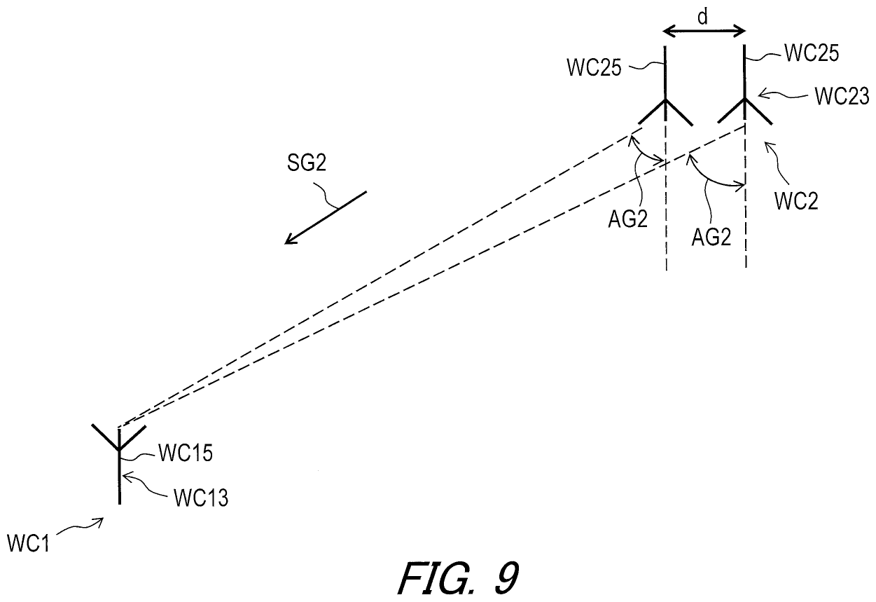

As seen in FIGS. 8 and 9, for example, the directional information INF11 can include an angle of departure AG2. The angle of departure AG2 is defined based on a relative position between the first wireless communicator circuitry WC1 and the second wireless communicator circuitry WC2. The electronic controller circuitry EC1 is configured to obtain the angle of departure AG2.

For example, the first antenna circuitry WC13 includes a first antenna WC15. The second antenna circuitry WC23 includes at least two second antennas WC25. Namely, the first wireless communicator circuitry WC1 includes the first antenna WC15. The second wireless communicator circuitry WC2 includes at least two second antennas WC25. The at least two second antennas WC25 are equally spaced.

The angle of departure AG2 is defined based on a positional relationship between the first antenna WC15 and the at least two second antennas WC25 of the second wireless communicator circuitry WC2 in the human-powered vehicle 2.

A total number of the at least two second antennas WC25 is greater than or equal to three. However, the total number of the at least two second antennas WC25 can be equal to two if needed or desired. The total number of the at least two second antennas WC25 is not limited to the illustrated embodiment.

The electronic controller circuitry EC1 is configured to generate the at least one control signal CS1 based on the angle of departure AG2. The electronic controller circuitry EC1 is configured to control the first wireless communicator circuitry WC1 to wirelessly transmit the at least one control signal CS1 based on the angle of departure AG2.

For example, the electronic controller circuitry EC1 is configured to control the first wireless communicator circuitry WC1 to wirelessly transmit a first control signal CS11 in a case where the angle of departure AG2 is greater than the first threshold TA1. The electronic controller circuitry EC1 is configured to control the first wireless communicator circuitry WC1 to wirelessly transmit a second control signal CS12 in a case where the angle of departure AG2 is equal to or less than the first threshold TA1 and greater than the second threshold TA2. The electronic controller circuitry EC1 is configured to control the first wireless communicator circuitry WC1 to wirelessly transmit a third control signal CS13 in a case where the angle of departure AG2 is equal to or less than the second threshold TA2.

The electronic controller circuitry EC1 is configured to calculate the angle of departure AG2 based on the direction-finding signal SG2 wirelessly transmitted from the second wireless communicator circuitry WC2. The electronic controller circuitry EC1 is configured to obtain a phase difference (ψ) and a wave length (λ) based on the direction-finding signal SG2 received by the first antenna. The at least two second antennas WC25 are arranged at a distance (d) defined between adjacent two of the at least two second antennas WC25. Thus, the electronic controller circuitry EC1 is configured to calculate the angle of departure AG2 based on the following formula (2). The electronic controller circuitry EC1 is configured to store the angle of departure AG2 in the memory EC12 as the information INF1. The electronic controller circuitry EC1 is configured to store the angle of departure AG2 in the memory EC12 as the directional information INF11.

$$A G 2 = arcsin ( \frac{ψ λ}{2 π d} ) \qquad ( 2 )$$

As seen in FIGS. 2 to 5, the electronic controller circuitry EC1 is configured to generate the at least one control signal CS1 to change a state of the additional electric device ED3 between at least two states based on the information INF1. The electronic controller circuitry EC1 is configured to control the first wireless communicator circuitry WC1 to wirelessly transmit the at least one control signal CS1 based on the information INF1.

For example, the at least one control signal CS1 includes a first control signal CS11, a second control signal CS12, and a third control signal CS13. The additional electric device ED3 has a first state, a second state, and a third state. The additional electric device ED3 is configured to change the state of the additional electric device ED3 from one of the second state and the third state to the first state in response to the first control signal CS11. The additional electric device ED3 is configured to change the state of the additional electric device ED3 from one of the first state and the third state to the second state in response to the second control signal CS12. The additional electric device ED3 is configured to change the state of the additional electric device ED3 from one of the first state and the second state to the third state in response to the third control signal CS13.

The electronic controller circuitry EC1 is configured to generate the first control signal CS11 in a case where the information INF1 meets a first condition. The electronic controller circuitry EC1 is configured to generate the second control signal CS12 in a case where the information INF1 meets a second condition. The electronic controller circuitry EC1 is configured to generate the third control signal CS13 in a case where the information INF1 meets a third condition. The first condition is different from the second condition and the third condition. The second condition is different from the third condition. The electronic controller circuitry EC1 is configured to control the first wireless communicator circuitry WC1 to wirelessly transmit the first control signal CS11, the second control signal CS12, or the third control signal CS13 based on the information INF1.

The electronic controller circuitry EC1 is configured to generate the first control signal CS11 in a case where the directional information INF11 meets the first condition. The electronic controller circuitry EC1 is configured to generate the second control signal CS12 in a case where the directional information INF11 meets the second condition. The electronic controller circuitry EC1 is configured to generate the third control signal CS13 in a case where the directional information INF11 meets the third condition. The electronic controller circuitry EC1 is configured to control the first wireless communicator circuitry WC1 to wirelessly transmit the first control signal CS11, the second control signal CS12, or the third control signal CS13 based on the directional information INF11.

The electronic controller circuitry EC1 is configured to generate the first control signal CS11 in a case where the angle of arrival AG1 meets the first condition. The electronic controller circuitry EC1 is configured to generate the second control signal CS12 in a case where the angle of arrival AG1 meets the second condition. The electronic controller circuitry EC1 is configured to generate the third control signal CS13 in a case where the angle of arrival AG1 meets the third condition. The electronic controller circuitry EC1 is configured to control the first wireless communicator circuitry WC1 to wirelessly transmit the first control signal CS11, the second control signal CS12, or the third control signal CS13 based on the angle of arrival AG1.

For example, the electronic controller circuitry EC1 is configured to generate the first control signal CS11 in a case where the angle of arrival AG1 is greater than the first threshold TA1. The electronic controller circuitry EC1 is configured to generate the second control signal CS12 in a case where the angle of arrival AG1 is equal to or less than the first threshold TA1 and greater than the second threshold TA2. The electronic controller circuitry EC1 is configured to generate the third control signal CS13 in a case where the angle of arrival AG1 is equal to or less than the second threshold TA2.

The electronic controller circuitry EC1 is configured to generate the first control signal CS11 in a case where the angle of departure AG2 meets the first condition. The electronic controller circuitry EC1 is configured to generate the second control signal CS12 in a case where the angle of departure AG2 meets the second condition. The electronic controller circuitry EC1 is configured to generate the third control signal CS13 in a case where the angle of departure AG2 meets the third condition. The electronic controller circuitry EC1 is configured to control the first wireless communicator circuitry WC1 to wirelessly transmit the first control signal CS11, the second control signal CS12, or the third control signal CS13 based on the angle of departure AG2.

For example, the electronic controller circuitry EC1 is configured to generate the first control signal CS11 in a case where the angle of departure AG2 is greater than the first threshold TA1. The electronic controller circuitry EC1 is configured to generate the second control signal CS12 in a case where the angle of departure AG2 is equal to or less than the first threshold TA1 and greater than the second threshold TA2. The electronic controller circuitry EC1 is configured to generate the third control signal CS13 in a case where the angle of departure AG2 is equal to or less than the second threshold TA2.

In a case where the additional electric device ED3 includes the suspension SS, for example, the electronic controller circuitry EC1 is configured to generate the at least one control signal CS1 to change a state of the suspension SS between at least two states based on the information INF1. The electronic controller circuitry EC1 is configured to control the first wireless communicator circuitry WC1 to wirelessly transmit the first control signal CS11, the second control signal CS12, or the third control signal CS13 based on the information INF1. The additional wireless communicator circuitry WC3 is configured to wirelessly receive the first control signal CS11, the second control signal CS12, or the third control signal CS13 from the first wireless communicator circuitry WC1.

The suspension SS is configured to receive the first control signal CS11, the second control signal CS12, or the third control signal CS13 via the additional wireless communicator circuitry WC3. The suspension SS is configured to change the state of the suspension SS from one of the second state and the third state to the first state in response to the first control signal CS11. The suspension SS is configured to change the state of the suspension SS from one of the first state and the third state to the second state in response to the second control signal CS12. The suspension SS is configured to change the state of the suspension SS from one of the first state and the second state to the third state in response to the third control signal CS13.

In a case where the additional electric device ED3 includes the adjustable seatpost AS, for example, the electronic controller circuitry EC1 is configured to generate the at least one control signal CS1 to change a state of the adjustable seatpost AS between at least two states based on the information INF1. The electronic controller circuitry EC1 is configured to control the first wireless communicator circuitry WC1 to wirelessly transmit the first control signal CS11, the second control signal CS12, or the third control signal CS13 based on the information INF1. The additional wireless communicator circuitry WC3 is configured to wirelessly receive the first control signal CS11, the second control signal CS12, or the third control signal CS13 from the first wireless communicator circuitry WC1.

The adjustable seatpost AS is configured to receive the first control signal CS11, the second control signal CS12, or the third control signal CS13 via the additional wireless communicator circuitry WC3. The adjustable seatpost AS is configured to change the state of the adjustable seatpost AS from one of the second state and the third state to the first state in response to the first control signal CS11. The adjustable seatpost AS is configured to change the state of the adjustable seatpost AS from one of the first state and the third state to the second state in response to the second control signal CS12. The adjustable seatpost AS is configured to change the state of the adjustable seatpost AS from one of the first state and the second state to the third state in response to the third control signal CS13.

In a case where the additional electric device ED3 includes the brake device BD, for example, the electronic controller circuitry EC1 is configured to generate the at least one control signal CS1 to restrict the brake device BD from generating the braking force based on the information INF1. The electronic controller circuitry EC1 is configured to control the first wireless communicator circuitry WC1 to wirelessly transmit the first control signal CS11, the second control signal CS12, or the third control signal CS13 based on the information INF1. The additional wireless communicator circuitry WC3 is configured to wirelessly receive the first control signal CS11, the second control signal CS12, or the third control signal CS13 from the first wireless communicator circuitry WC1.

The brake device BD is configured to receive the first control signal CS11, the second control signal CS12, or the third control signal CS13 via the additional wireless communicator circuitry WC3. The brake device BD is configured to change the state of the brake device BD from one of the second state and the third state to the first state in response to the first control signal CS11. The brake device BD is configured to change a state of the brake device BD from one of the first state and the third state to the second state in response to the second control signal CS12. The brake device BD is configured to change a state of the brake device BD from one of the first state and the second state to the third state in response to the third control signal CS13.

In a case where the additional electric device ED3 includes the assist drive unit DU, for example, the electronic controller circuitry EC1 is configured to generate the at least one control signal CS1 to change an assist ratio of the assist drive unit DU based on the information INF1. The electronic controller circuitry EC1 is configured to control the first wireless communicator circuitry WC1 to wirelessly transmit the first control signal CS11, the second control signal CS12, or the third control signal CS13 based on the information INF1. The additional wireless communicator circuitry WC3 is configured to wirelessly receive the first control signal CS11, the second control signal CS12, or the third control signal CS13 from the first wireless communicator circuitry WC1.

The assist drive unit DU is configured to receive the first control signal CS11, the second control signal CS12, or the third control signal CS13 via the additional wireless communicator circuitry WC3. The assist drive unit DU is configured to change the state of the assist drive unit DU from one of the second state and the third state to the first state in response to the first control signal CS11. The assist drive unit DU is configured to change a state of the assist drive unit DU from one of the first state and the third state to the second state in response to the second control signal CS12. The assist drive unit DU is configured to change a state of the assist drive unit DU from one of the first state and the second state to the third state in response to the third control signal CS13.

In a case where the additional electric device ED3 includes the gear changer RD, for example, the electronic controller circuitry EC1 is configured to generate the at least one control signal CS1 to change a gear ratio of the gear changer RD based on the information

INF1. The electronic controller circuitry EC1 is configured to control the first wireless communicator circuitry WC1 to wirelessly transmit the first control signal CS11, the second control signal CS12, or the third control signal CS13 based on the information INF1. The additional wireless communicator circuitry WC3 is configured to wirelessly receive the first control signal CS11, the second control signal CS12, or the third control signal CS13 from the first wireless communicator circuitry WC1.

The gear changer RD is configured to receive the first control signal CS11, the second control signal CS12, or the third control signal CS13 via the additional wireless communicator circuitry WC3. The gear changer RD is configured to change the state of the gear changer RD from one of the second state and the third state to the first state in response to the first control signal CS11. The gear changer RD is configured to change the state of the gear changer RD from one of the first state and the third state to the second state in response to the second control signal CS12. The gear changer RD is configured to change the state of the gear changer RD from one of the first state and the second state to the third state in response to the third control signal CS13.

As seen in FIG. 2, the control system 10 of the human-powered vehicle 2 comprises a sensor 12. The sensor 12 is configured to be connected to at least one of the first wireless communicator circuitry WC1, the second wireless communicator circuitry WC2 and the electronic controller circuitry EC1. The sensor 12 is configured to be electrically connected to at least one of the first wireless communicator circuitry WC1, the second wireless communicator circuitry WC2 and the electronic controller circuitry EC1. The sensor 12 is configured to transmit the information INF1 relating to the positional relationship to the electronic controller circuitry EC1.

In the present embodiment, the sensor 12 is configured to be electrically connected to the first wireless communicator circuitry WC1 and the electronic controller circuitry EC1. The sensor 12 includes the first signal transmitting circuitry WC11 and the first signal receiving circuitry WC12. The sensor 12 is electrically connected to the first antenna circuitry WC13.

The first wireless communicator circuitry WC1 is provided to a stationary portion of the human-powered vehicle 2. The sensor 12 is provided to a stationary portion of the human-powered vehicle 2. For example, the electric device ED1 is mounted to the vehicle body 8. The circuit board EC13 is secured to the base member ED11. Namely, the first wireless communicator circuitry WC1 is coupled to the vehicle body 8 via the circuit board EC13 and the base member ED11. The sensor 12 is coupled to the vehicle body 8 via the circuit board EC13 and the base member ED11.

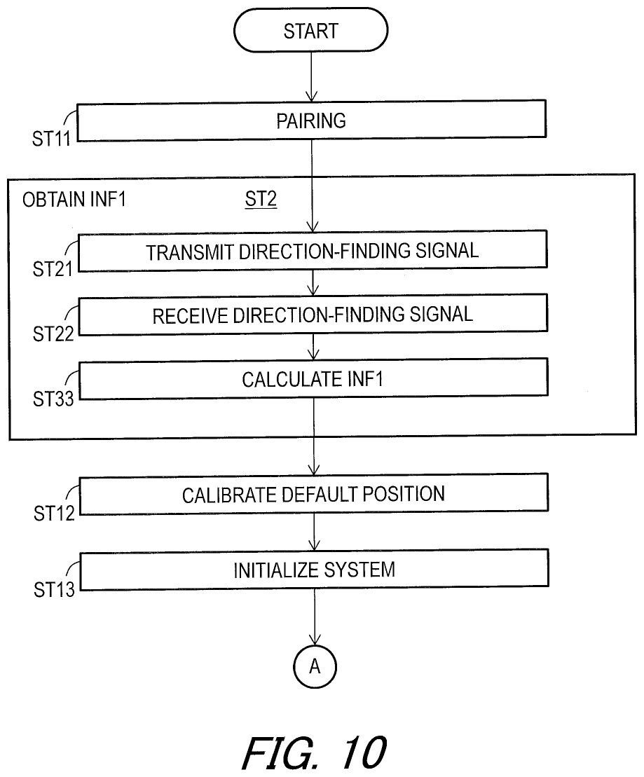

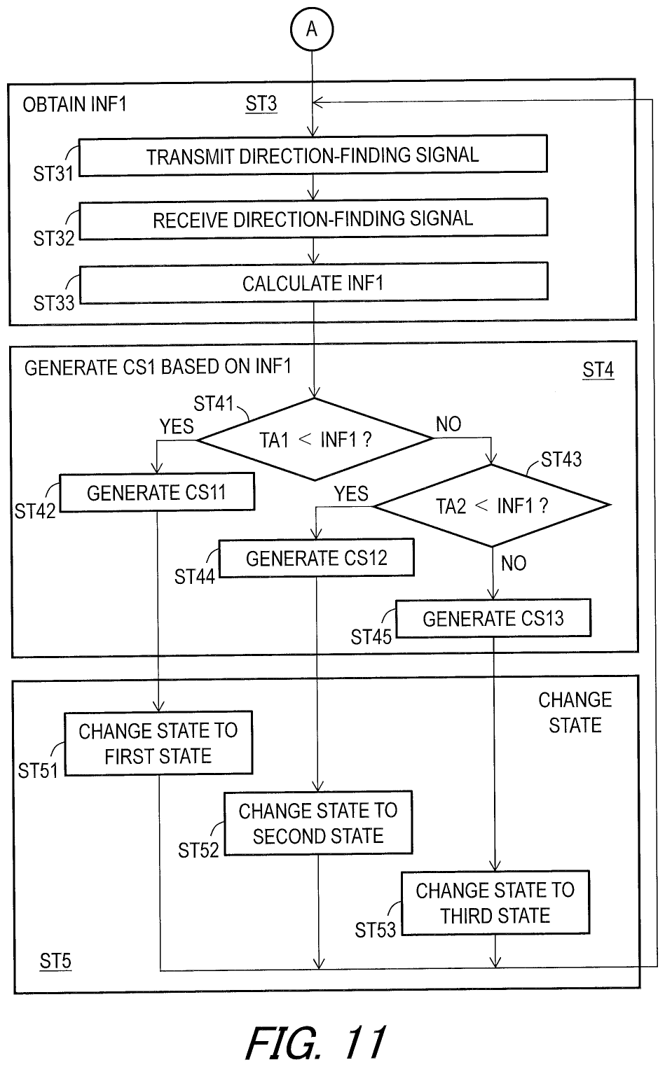

The first control executed by the control system 10 based on the information INF1 will be described below referring to FIGS. 10 and 11.

As seen in FIG. 10, the electronic controller circuitry EC1 executes pairing between the first wireless communicator circuitry WC1 and the second wireless communicator circuitry WC2 (step ST11). The electronic controller circuitry EC1 obtains the information INF1 (step ST2). For example, the second electronic controller circuitry EC2 controls the second wireless communicator circuitry WC2 to wirelessly transmit the direction-finding signal SG2 at specific cycles (step ST21). The first wireless communicator circuitry WC1 wirelessly receives the direction-finding signal SG2 (step ST22). The electronic controller circuitry EC1 calculates the information INF1 based on the direction-finding signal SG2 (step ST23). Specifically, the electronic controller circuitry EC1 calculates the angle of arrival AG1 or the angle of departure AG2 based on the direction-finding signal SG2 (step ST23). Thus, the electronic controller circuitry EC1 obtains the angle of arrival AG1 or the angle of departure AG2 as the information INF1 or the directional information INF11. The electronic controller circuitry EC1 calibrates the default position obtained from the information INF1 (step ST12). The electronic controller circuitry EC1 initializes the system of the electric device ED1 (step ST13).

As seen in FIG. 11, the electronic controller circuitry EC1 obtains the information INF1 (step ST3). For example, the second electronic controller circuitry EC2 controls the second wireless communicator circuitry WC2 to wirelessly transmit the direction-finding signal SG2 at specific cycles (step ST31). The first wireless communicator circuitry WC1 wirelessly receives the direction-finding signal SG2 (step ST32). The electronic controller circuitry EC1 calculates the information INF1 based on the direction-finding signal SG2 (step ST33). Specifically, the electronic controller circuitry EC1 calculates the angle of arrival AG1 or the angle of departure AG2 based on the direction-finding signal SG2 (step ST33). Thus, the electronic controller circuitry EC1 obtains the angle of arrival AG1 or the angle of departure AG2 as the information INF1 or the directional information INF11.

The electronic controller circuitry EC1 generates the at least one control signal CS1 based on the information INF1 (step ST4). For example, the electronic controller circuitry EC1 compares the information INF1 with the first threshold TA1 (step ST41). The electronic controller circuitry EC1 generates the first control signal CS11 in a case where a value of the information INF1 is greater than the first threshold TA1 (step ST41 and ST42). Specifically, the electronic controller circuitry EC1 generates the first control signal CS11 in a case where the angle of arrival AG1 or the angle of departure AG2 is greater than the first threshold TA1 (step ST41 and ST42).

The electronic controller circuitry EC1 compares the information INF1 with the first threshold TA1 and the second threshold TA2 in a case where the value of the information INF1 is equal to or less than the first threshold TA1 (step ST41 and ST43). The electronic controller circuitry EC1 generates the second control signal CS12 in a case where the value of the information INF1 is greater than the second threshold TA2 (step ST43 and ST44). Specifically, the electronic controller circuitry EC1 generates the second control signal CS12 in a case where the angle of arrival AG1 or the angle of departure AG2 is greater than the second threshold TA2 (step ST43 and ST44).

The electronic controller circuitry EC1 generates the third control signal CS13 in a case where the value of the information INF1 is equal to or less than the second threshold TA2 (step ST43 and ST45). Specifically, the electronic controller circuitry EC1 generates the third control signal CS13 in a case where the angle of arrival AG1 or the angle of departure AG2 is equal to or less than the second threshold TA2 (step ST43 and ST45).

The additional electronic controller circuitry EC3 changes the state of the additional electric device ED3 based on the at least one control signal CS1 (step ST5). For example, the additional electronic controller circuitry EC3 changes the state of the additional electric device ED3 to the first state based on the first control signal CS11 (step ST51). The additional electronic controller circuitry EC3 changes the state of the additional electric device ED3 to the second state based on the second control signal CS12 (step ST52). The additional electronic controller circuitry EC3 changes the state of the additional electric device ED3 to the third state based on the third control signal CS13 (step ST53). Thus, it is possible to change the state of the additional electric device ED3 depending on the positional relationship between the first wireless communicator circuitry WC1 and the second wireless communicator circuitry WC2. The process returns to the step ST3 after changing the state of the additional electric device ED3.

In a case where the second electric device ED2 includes the adjustable seatpost AS and where the additional electric device ED3 includes the suspension SS, the suspension SS changes its state based on the motion of the adjustable seatpost AS.

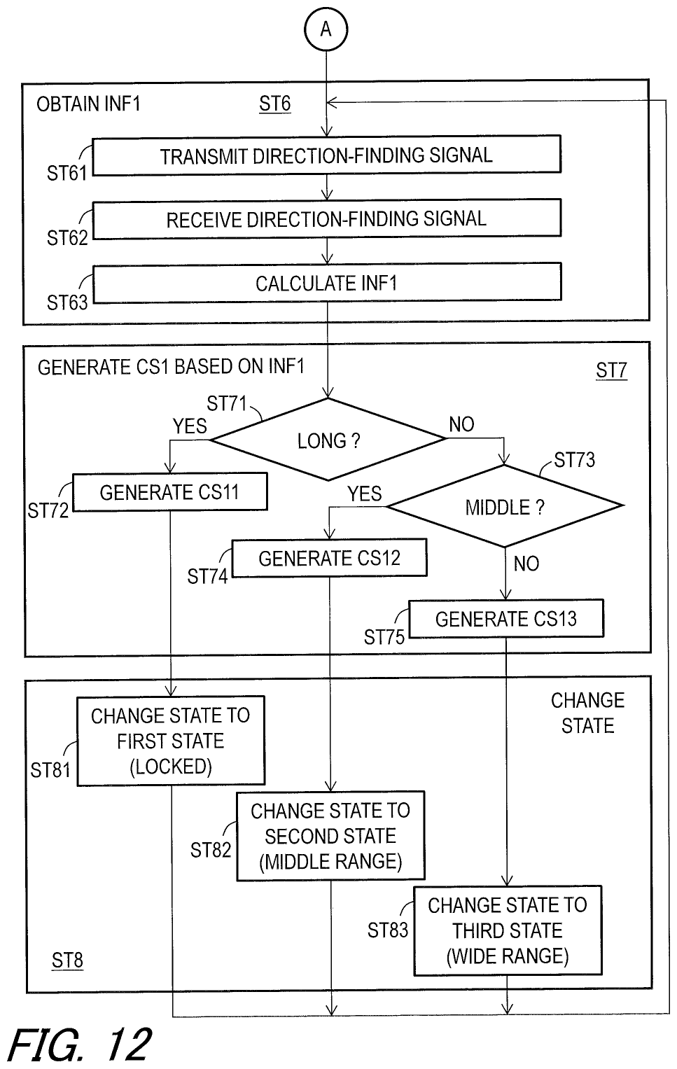

As seen in FIG. 12, for example, in a case where the angle of arrival AG1 or the angle of departure AG2 is greater than the first threshold TA1, the length of the adjustable seatpost AS is longer than a first predetermined length, which indicates that the adjustable seatpost AS has the longer length and the position of the saddle 8S is high. In a case where the adjustable seatpost AS has the longer length, the suspension SS changes the state to the first state in response to the first control signal CS11 (steps ST71, ST72, and ST81). Namely, in a case where the adjustable seatpost AS has the longer length, the suspension SS absorbs or damps shocks or vibrations within the first stroke or under the first damping performance in the first state. For example, the first stroke is shorter than the second stroke and the third stroke. The second stroke is shorter than the third stroke. The first stroke can be zero. The first damping performance is lower than the second damping performance and the third damping performance. The second damping performance is lower than the third damping performance. Thus, in a case where the adjustable seatpost AS has the longer length, the suspension SS is locked not to absorbs or damps shocks or vibrations. In a case where the angle of arrival AG1 or the angle of departure AG2 is less than

or equal to the first threshold TA1 and greater than the second threshold TA1, the length of the adjustable seatpost AS is shorter than or equal to the first predetermined length and longer than a second predetermined length, which indicates that the adjustable seatpost AS has the middle length and the position of the saddle 8S is middle. In a case where the adjustable seatpost AS has the middle length, the suspension SS changes the state to the second state in response to the second control signal CS12 (steps ST71, ST73, ST74, and ST82). Namely, in a case where the adjustable seatpost AS has the middle length, the suspension SS absorbs or damps shocks or vibrations within the second stroke or under the second damping performance in the second state. Thus, in a case where the adjustable seatpost AS has the middle length, the suspension SS can absorb or damp shocks or vibrations within a middle range.

In a case where the angle of arrival AG1 or the angle of departure AG2 is less than or equal to the second threshold TA1, the length of the adjustable seatpost AS is shorter than or equal to the second predetermined length, which indicates that the adjustable seatpost AS has the shorter length and the position of the saddle 8S is low. In a case where the adjustable seatpost AS has the shorter length, the suspension SS changes the state to the third state in response to the third control signal CS12 (steps ST73, ST75, and ST83). Namely, in a case where the adjustable seatpost AS has the shorter length, the suspension SS absorbs or damps shocks or vibrations within the third stroke or under the third damping performance in the third state. Thus, in a case where the adjustable seatpost AS has the shorter length, the suspension SS can absorb or damp shocks or vibrations within a wide range.

In a case where the second electric device ED2 includes the suspension SS and where the additional electric device ED3 includes the suspension SS, the suspension SS changes its state based on the motion of the suspension SS.

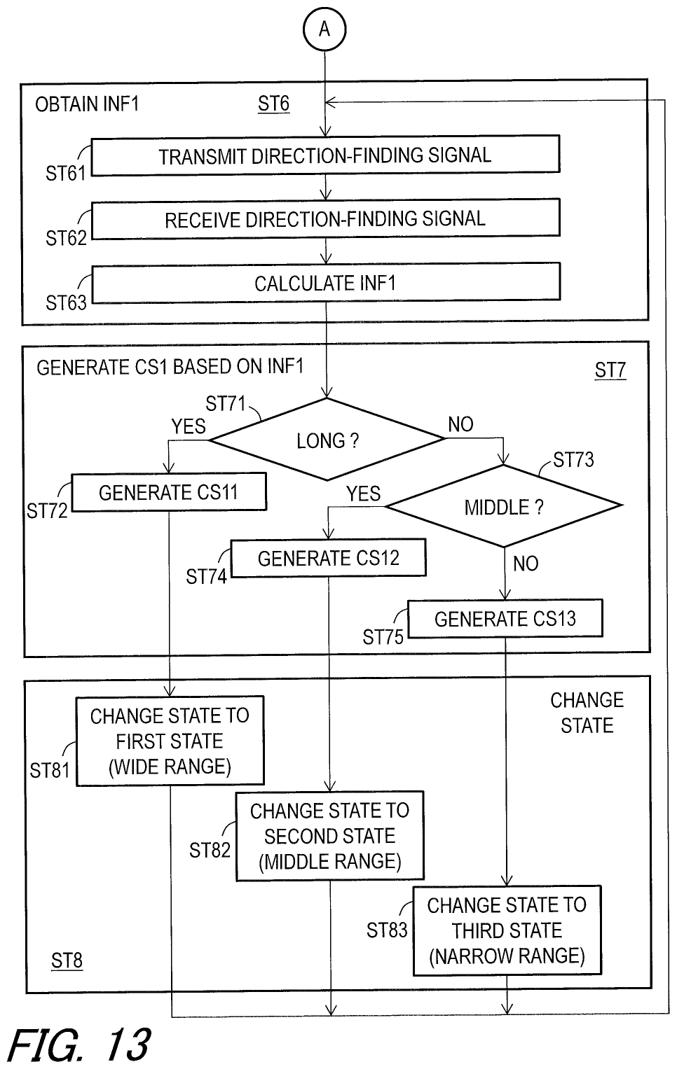

As seen in FIG. 13, for example, in a case where the angle of arrival AG1 or the angle of departure AG2 is greater than the first threshold TA1, the length of the suspension SS is longer than a first predetermined length, which indicates that the suspension SS has the longer length. In a case where the suspension SS has the longer length, the suspension SS changes the state to the first state in response to the first control signal CS11 (steps ST71, ST72, and ST81). Namely, in a case where the suspension SS has the longer length, the suspension SS absorbs or damps shocks or vibrations within the first stroke or under the first damping performance in the first state. For example, the first stroke is longer than the second stroke and the third stroke. The second stroke is longer than the third stroke. The first damping performance is higher than the second damping performance and the third damping performance. The second damping performance is higher than the third damping performance. Thus, in a case where the suspension SS has the longer length, the suspension SS can absorb or damp shocks or vibrations within a wide range.

In a case where the angle of arrival AG1 or the angle of departure AG2 is less than or equal to the first threshold TA1 and greater than the second threshold TA1, the length of the suspension SS is shorter than or equal to the first predetermined length and longer than a second predetermined length, which indicates that the suspension SS has the middle length and the position of the saddle 8S is middle. In a case where the suspension SS has the middle length, the suspension SS changes the state to the second state in response to the second control signal CS12 (steps ST71, ST73, ST74, and ST82). Namely, in a case where the suspension SS has the middle length, the suspension SS absorbs or damps shocks or vibrations within the second stroke or under the second damping performance in the second state. Thus, in a case where the suspension SS has the middle length, the suspension SS can absorb or damp shocks or vibrations within a middle range.

In a case where the angle of arrival AG1 or the angle of departure AG2 is less than or equal to the second threshold TA1, the length of the suspension SS is shorter than or equal to the second predetermined length, which indicates that the suspension SS has the shorter length and the position of the saddle 8S is low. In a case where the suspension SS has the shorter length, the suspension SS changes the state to the third state in response to the third control signal CS12 (steps ST73, ST75, and ST83). Namely, in a case where the suspension SS has the shorter length, the suspension SS absorbs or damps shocks or vibrations within the third stroke or under the third damping performance in the third state. Thus, in a case where the suspension SS has the shorter length, the suspension SS can absorb or damp shocks or vibrations within a narrow range.

In a case where the second electric device ED2 includes the operating device ST and where the additional electric device ED3 includes the brake device BD, the brake device BD changes its state based on the motion of the operating device ST. The motion of the operating device ST includes the motion of the handlebar 8H. Namely, the brake device BD changes its state based on the motion of the handlebar 8H.

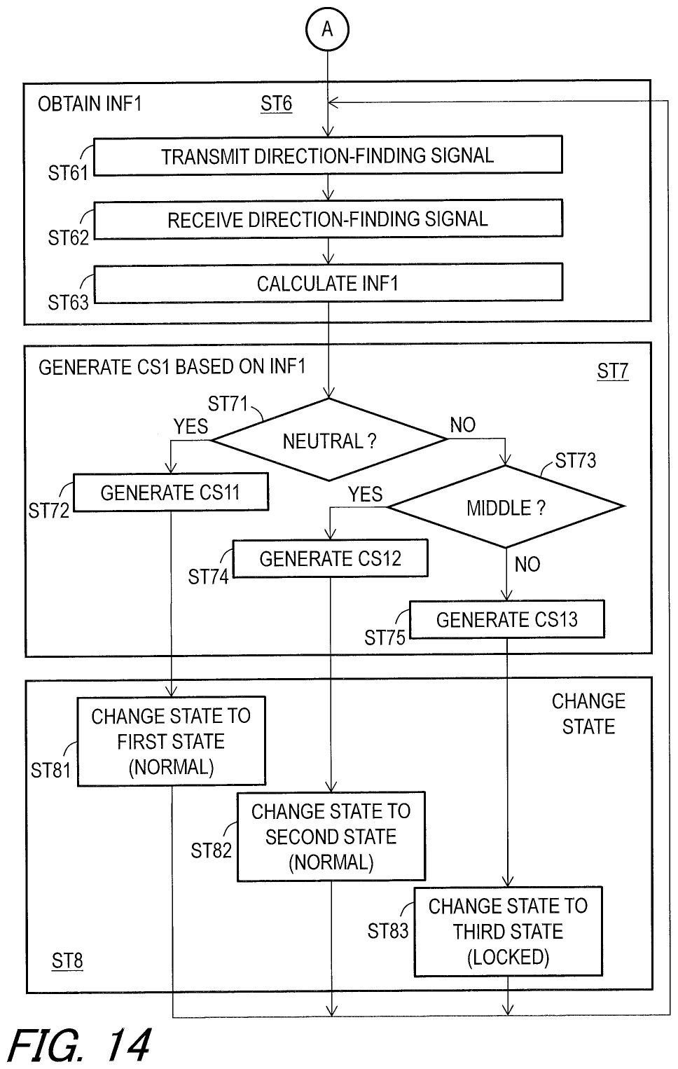

As seen in FIG. 14, for example, in a case where the angle of arrival AG1 or the angle of departure AG2 is greater than the first threshold TA1, the operating device ST is in a neutral position with respect to the frame 8F, which indicates that the handlebar 8H is in a neutral position about a rotational axis with respect to the frame 8F. In a case where the operating device ST is in the neutral position, the brake device BD changes the state to the first state in response to the first control signal CS11 (steps ST71, ST72, and ST81). Namely, in a case where the operating device ST is in the neutral position, the brake device BD operates in a normal manner in the first state. Thus, in a case where the operating device ST is in the neutral position, the brake device BD applies the braking force to the wheel 7A and/or 7B in response to the operation of the operating device ST.

In a case where the angle of arrival AG1 or the angle of departure AG2 is less than or equal to the first threshold TA1 and greater than the second threshold TA1, the operating device ST is in a middle position with respect to the frame 8F, which indicates that the handlebar 8H is in a middle position about the rotational axis with respect to the frame 8F. In a case where the operating device ST is in the middle position, the brake device BD changes the state to the second state in response to the second control signal CS12 (steps ST71, ST73, ST74, and ST82). Namely, in a case where the operating device ST is in the middle position, the brake device BD operates in a normal manner in the second state. Thus, in a case where the operating device ST is in the middle position, the brake device BD applies the braking force to the wheel 7A and/or 7B in response to the operation of the

In a case where the angle of arrival AG1 or the angle of departure AG2 is less than or equal to the second threshold TA1, the operating device ST is in an end position with respect to the frame 8F, which indicates that the handlebar 8H is in an end position about the rotational axis with respect to the frame 8F. In a case where the operating device ST is in the end position, the brake device BD changes the state to the third state in response to the third control signal CS12 (steps ST73, ST75, and ST83). For example, in a case where the operating device ST is in the end position, the brake device BD is locked not to apply the braking force regardless of the operation of the operating device ST in the third state.

In a case where the second electric device ED2 includes the operating device ST and where the additional electric device ED3 includes the gear changer RD, the gear changer RD changes its state based on the motion of the operating device ST. The motion of the operating device ST includes the motion of the handlebar 8H. Namely, the gear changer RD changes its state based on the motion of the handlebar 8H.

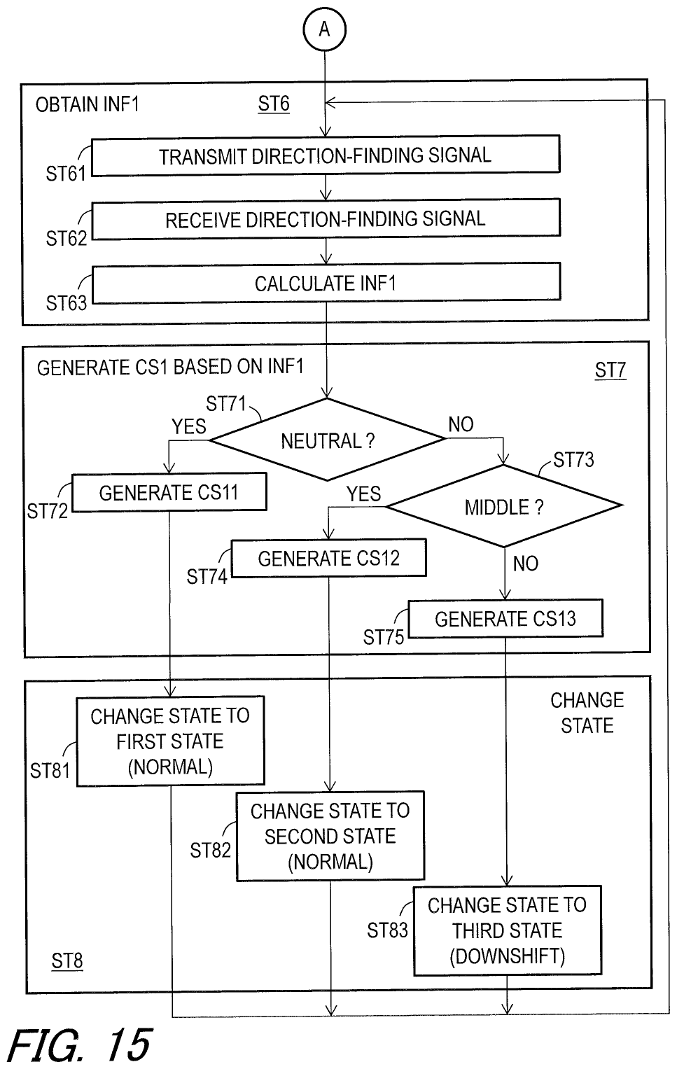

As seen in FIG. 15, for example, in a case where the angle of arrival AG1 or the angle of departure AG2 is greater than the first threshold TA1, the operating device ST is in a neutral position with respect to the frame 8F, which indicates that the handlebar 8H is in a neutral position about a rotational axis with respect to the frame 8F. In a case where the operating device ST is in the neutral position, the gear changer RD changes the state to the first state in response to the first control signal CS11 (steps ST71, ST72, and ST81). Namely, in a case where the operating device ST is in the neutral position, the gear changer RD operates in a normal manner in the first state. Thus, in a case where the operating device ST is in the neutral position, the gear changer RD applies the braking force to the wheel 7A and/or 7B in response to the operation of the operating device ST.

In a case where the angle of arrival AG1 or the angle of departure AG2 is less than or equal to the first threshold TA1 and greater than the second threshold TA1, the operating device ST is in a middle position with respect to the frame 8F, which indicates that the handlebar 8H is in a middle position about the rotational axis with respect to the frame 8F. In a case where the operating device ST is in the middle position, the gear changer RD changes the state to the second state in response to the second control signal CS12 (steps ST71, ST73, ST74, and ST82). Namely, in a case where the operating device ST is in the middle position, the gear changer RD operates in a normal manner in the second state. Thus, in a case where the operating device ST is in the middle position, the gear changer RD applies the braking force to the wheel 7A and/or 7B in response to the operation of the

In a case where the angle of arrival AG1 or the angle of departure AG2 is less than or equal to the second threshold TA1, the operating device ST is in an end position with respect to the frame 8F, which indicates that the handlebar 8H is in an end position about the rotational axis with respect to the frame 8F. In a case where the operating device ST is in the end position, the gear changer RD changes the state to the third state in response to the third control signal CS12 (steps ST73, ST75, and ST83). For example, in a case where the operating device ST is in the end position, the gear changer RD executes downshifting regardless of the operation of the operating device ST in the third state.

In a case where the second electric device ED2 includes the operating device ST and where the additional electric device ED3 includes the assist drive unit DU, the assist drive unit DU changes its state based on the motion of the operating device ST. The motion of the operating device ST includes the motion of the handlebar 8H. Namely, the assist drive unit DU changes its state based on the motion of the handlebar 8H.

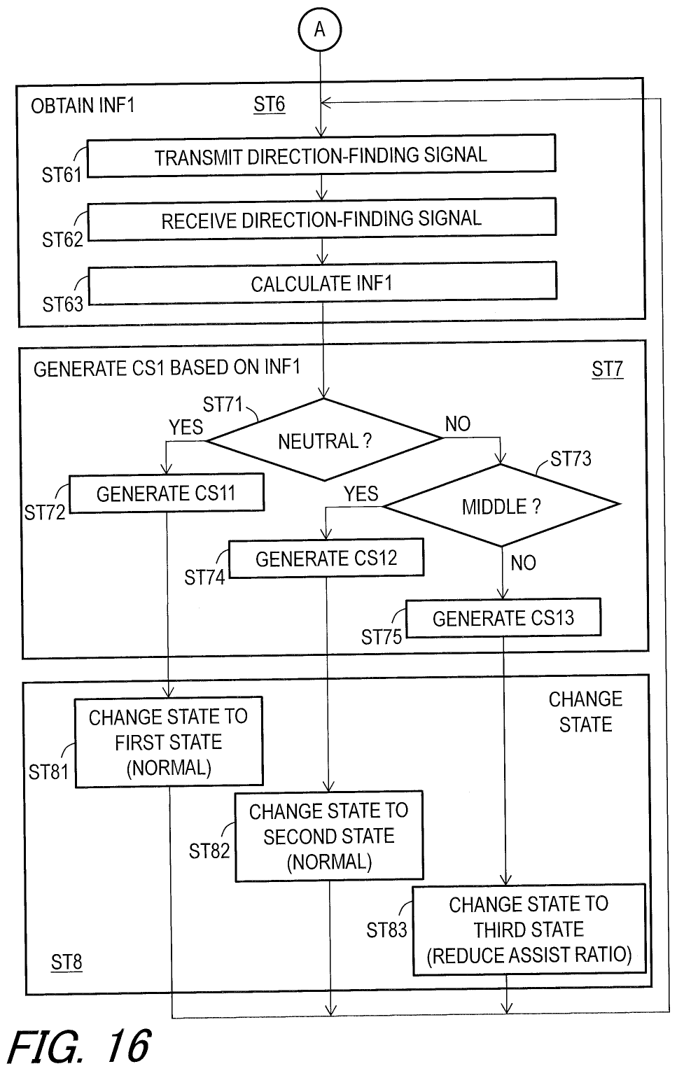

As seen in FIG. 16, for example, in a case where the angle of arrival AG1 or the angle of departure AG2 is greater than the first threshold TA1, the operating device ST is in a neutral position with respect to the frame 8F, which indicates that the handlebar 8H is in a neutral position about a rotational axis with respect to the frame 8F. In a case where the operating device ST is in the neutral position, the assist drive unit DU changes the state to the first state in response to the first control signal CS11 (steps ST71, ST72, and ST81). Namely, in a case where the operating device ST is in the neutral position, the assist drive unit DU operates in a normal manner in the first state. Thus, in a case where the operating device ST is in the neutral position, the assist drive unit DU applies the braking force to the wheel 7A and/or 7B in response to the operation of the operating device ST.

In a case where the angle of arrival AG1 or the angle of departure AG2 is less than or equal to the first threshold TA1 and greater than the second threshold TA1, the operating device ST is in a middle position with respect to the frame 8F, which indicates that the handlebar 8H is in a middle position about the rotational axis with respect to the frame 8F. In a case where the operating device ST is in the middle position, the assist drive unit DU changes the state to the second state in response to the second control signal CS12 (steps ST71, ST73, ST74, and ST82). Namely, in a case where the operating device ST is in the middle position, the assist drive unit DU operates in a normal manner in the second state. Thus, in a case where the operating device ST is in the middle position, the assist drive unit DU applies the braking force to the wheel 7A and/or 7B in response to the operation of the

In a case where the angle of arrival AG1 or the angle of departure AG2 is less than or equal to the second threshold TA1, the operating device ST is in an end position with respect to the frame 8F, which indicates that the handlebar 8H is in an end position about the rotational axis with respect to the frame 8F. In a case where the operating device ST is in the end position, the assist drive unit DU changes the state to the third state in response to the third control signal CS12 (steps ST73, ST75, and ST83). For example, in a case where the operating device ST is in the end position, the assist drive unit DU reduces the assist ratio regardless of the operation of the operating device ST.

In a case where the electric device ED includes the adjustable seatpost AS, where the second electric device ED2 includes the wearable device WD, and where the additional electric device ED3 includes the suspension SS, the suspension SS changes its state based on the motion of the wearable device WD relative to the adjustable seatpost AS. Namely, in a case where the wearable device WD is attached to the rider's body such as the rider's waist or the rider's head, the suspension SS changes its state based on the motion of the rider's body relative to the saddle 8S.

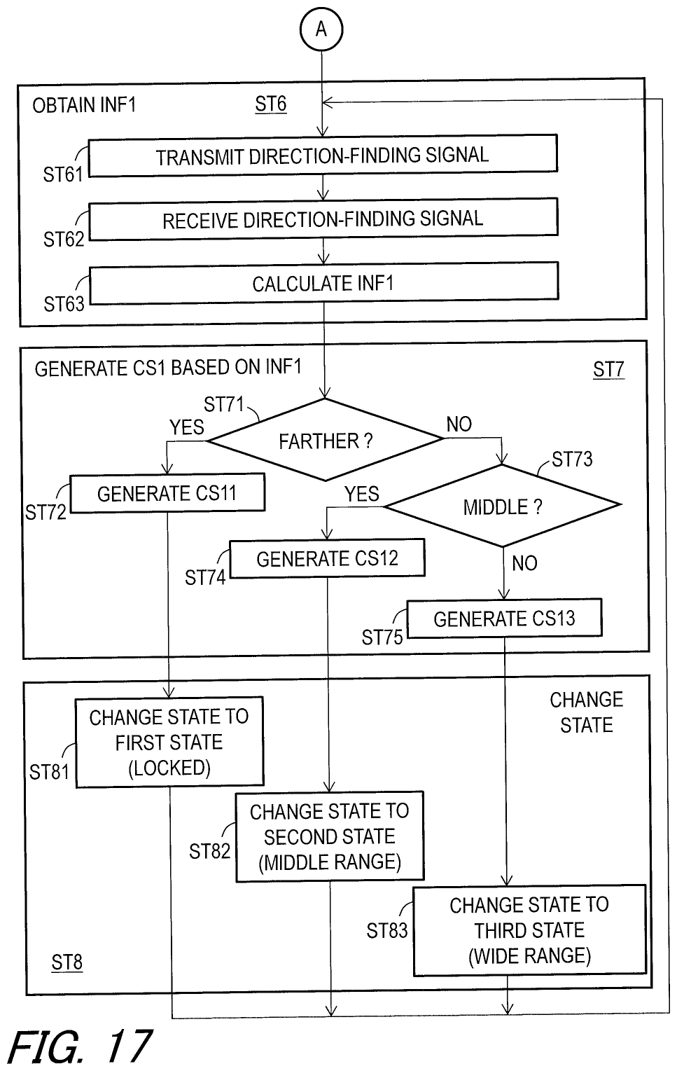

As seen in FIG. 17, for example, in a case where the angle of arrival AG1 or the angle of departure AG2 is greater than the first threshold TA1, the wearable device WD is farther from the adjustable seatpost AS than a first predetermined distance, which indicates that the rider's body moves away from the saddle 8S. Namely, the rider is climbing out of the saddle 8S in a state where the wearable device WD is father than the first predetermined distance.

In a case where the wearable device WD is farther from the adjustable seatpost AS than the first predetermined distance, the suspension SS changes the state to the first state in response to the first control signal CS11 (steps ST71, ST72, and ST81). Namely, in a case where the wearable device WD is farther from the adjustable seatpost AS than the first predetermined distance, the suspension SS absorbs or damps shocks or vibrations within the first stroke or under the first damping performance in the first state. For example, the first stroke is shorter than the second stroke and the third stroke. The second stroke is shorter than the third stroke. The first stroke can be zero. The first damping performance is lower than the second damping performance and the third damping performance. The second damping performance is lower than the third damping performance. Thus, in a case where the wearable device WD is farther from the adjustable seatpost AS than the first predetermined distance, the suspension SS is locked not to absorbs or damps shocks or vibrations.

In a case where the angle of arrival AG1 or the angle of departure AG2 is less than or equal to the first threshold TA1 and greater than the second threshold TA1, the length of the wearable device WD is shorter than or equal to the first predetermined distance and longer than a second predetermined distance, which indicates that the wearable device WD is away from the adjustable seatpost AS at a middle distance. In a case where the wearable device WD is away from the adjustable seatpost AS at a middle distance, the suspension SS changes the state to the second state in response to the second control signal CS12 (steps ST71, ST73, ST74, and ST82). Namely, in a case where the wearable device WD is away from the adjustable seatpost AS at a middle distance, the suspension SS absorbs or damps shocks or vibrations within the second stroke or under the second damping performance in the second state. Thus, in a case where the wearable device WD is away from the adjustable seatpost AS at a middle distance, the suspension SS can absorb or damp shocks or vibrations within a middle range.

In a case where the angle of arrival AG1 or the angle of departure AG2 is less than or equal to the second threshold TA1, the length of the wearable device WD is shorter than or equal to the second predetermined distance, which indicates that the wearable device WD is away from the adjustable seatpost AS at a short distance. Namely, the rider is on the saddle 8S in a state where the wearable device WD is away from the adjustable seatpost AS at a short distance. In a case where the wearable device WD is away from the adjustable seatpost AS at a short distance, the suspension SS changes the state to the third state in response to the third control signal CS12 (steps ST73, ST75, and ST83). Namely, in a case where the wearable device WD is away from the adjustable seatpost AS at a short distance, the suspension SS absorbs or damps shocks or vibrations within the third stroke or under the third damping performance in the third state. Thus, in a case where the wearable device WD is away from the adjustable seatpost AS at a short distance, the suspension SS can absorb or damp shocks or vibrations within a wide range.

The position detection system used in the control system 10 can be utilized along with another sensor such as a position sensor and a motion sensor. In such modifications, the inclination angle of the human-powered vehicle 2 relative to the road can be detected and utilized to control the device ED if needed or desired. The inclination angle can indicate the inclination angle during cornering of the human-powered vehicle 2.

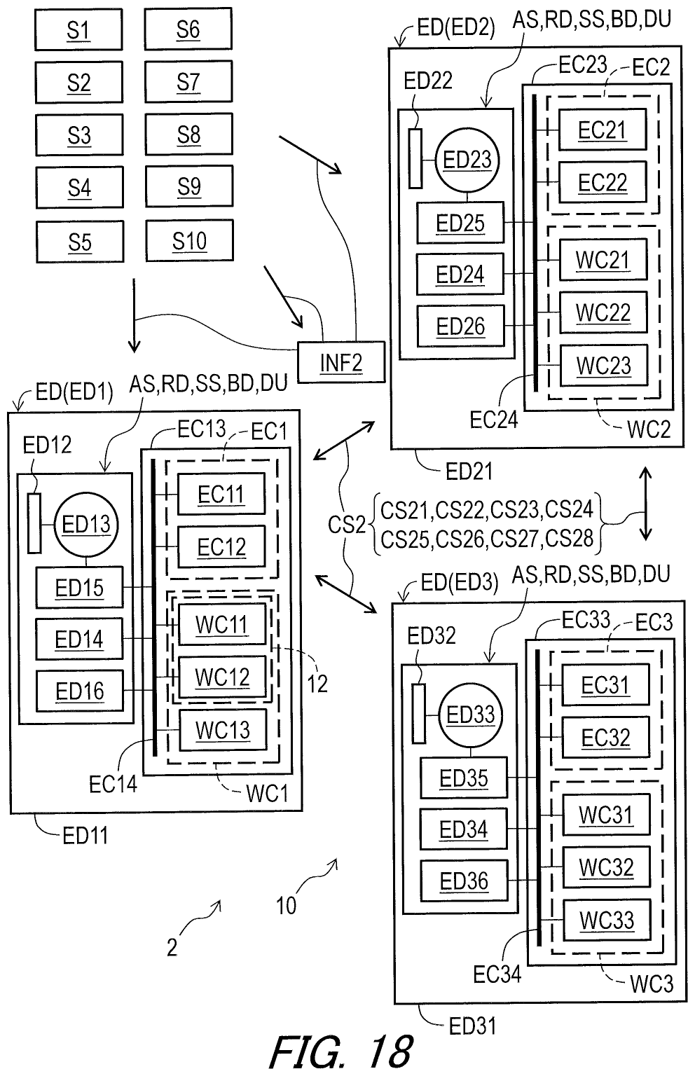

As seen in FIG. 18, in the modification of the above-mentioned embodiment, the second electronic controller circuitry EC2 can also be referred to as electronic controller circuitry EC2. The additional electronic controller circuitry EC3 can also be referred to as electronic controller circuitry EC3. Namely, the control system 10 of the human-powered vehicle 2 comprises the electronic controller circuitry EC1. The control system 10 of the human-powered vehicle 2 comprises the electronic controller circuitry EC2. The control system 10 of the human-powered vehicle 2 comprises the electronic controller circuitry EC3.

The first wireless communicator circuitry WC1 can also be referred to as wireless communicator circuitry WC1. The second wireless communicator circuitry WC2 can also be referred to as wireless communicator circuitry WC2. The additional wireless communicator circuitry WC3 can also be referred to as wireless communicator circuitry WC3. Thus, the control system 10 includes the wireless communicator circuitry WC1, the wireless communicator circuitry WC2, and the wireless communicator circuitry WC3.

The control system 10 includes a pressure sensor S1, an acceleration sensor S2, a handlebar load sensor S3, a saddle load sensor S4, an assist power sensor S5, a rider motion sensor S6, a chain state sensor S7, a speed sensor S8, a cadence sensor S9, and a crank power sensor S10. The pressure sensor S1 can also be referred to as a sensor S1. The acceleration sensor S2 can also be referred to as a sensor S2. The handlebar load sensor S3 can also be referred to as a sensor S3. The saddle load sensor S4 can also be referred to as a sensor S4. The assist power sensor S5 can also be referred to as a sensor S5. The rider motion sensor S6 can also be referred to as a sensor S6. The chain state sensor S7 can also be referred to as a sensor S7. The speed sensor S8 can also be referred to as a sensor S8. The cadence sensor S9 can also be referred to as a sensor S9. The crank power sensor S10 can also be referred to as a sensor S10.

The pressure sensor S1 is configured to sense air pressure in a tire of the wheel 7A and/or 7B (see e.g., FIG. 1) as a tire air pressure. The acceleration sensor S2 is configured to sense acceleration applied to the human-powered vehicle 2 as vehicle acceleration. The acceleration sensor S2 is configured to sense a posture of the human-powered vehicle 2 as vehicle acceleration. The acceleration sensor S2 is configured to sense an inclination angle of the human-powered vehicle 2 as vehicle acceleration. The handlebar load sensor S3 is configured to sense a load applied to the handlebar 8H (see e.g., FIG. 1) or a change in a position of the handlebar 8H (see e.g., FIG. 1) as a handlebar load. The saddle load sensor S4 is configured to sense load applied to the saddle 8S (see e.g., FIG. 1) or a change in a position of the saddle 8S (see e.g., FIG. 1) as a saddle load. The saddle load sensor S4 is configured to obtain, as a first saddle load, first load applied to the saddle 8S (see e.g., FIG. 1) or a change in a position of the saddle 8S (see e.g., FIG. 1) along a longitudinal direction of the adjustable seatpost AS. The saddle load sensor S4 is configured to obtain, as a second saddle load, second load applied to the saddle 8S (see e.g., FIG. 1) or a change in a position of the saddle 8S (see e.g., FIG. 1) in a transverse direction of the human-powered vehicle 2. The information obtained by the sensors can be selected by the control system 10 and/or the user if necessary.

The assist power sensor S5 is configured to sense assist power of the assist drive unit DU (see e.g., FIG. 1) as an assist power output. The rider motion sensor S6 is configured to sense a rider's motion. The chain state sensor S7 is configured to sense a state of the chain 5 (see e.g., FIG. 1) as a chain state. For example, the chain state sensor S7 is configured to sense vibration of the chain 5 (see e.g., FIG. 1) as the chain state. The speed sensor S8 is configured to sense a speed of the human-powered vehicle 2 as a running speed. For example, the speed sensor S8 is configured to sense a rotational speed of the wheel 7A and/or 7B (see e.g., FIG. 1) as the running speed. The cadence sensor S9 is configured to obtain a cadence (e.g., a rotational speed of the crank 3 (see e.g., FIG. 1)). The crank power sensor S10 is configured to obtain crank torque applied to the crank 3 (see e.g., FIG. 1) from the user.

Each of the pressure sensor S1, the acceleration sensor S2, the handlebar load sensor S3, the saddle load sensor S4, the assist power sensor S5, the rider motion sensor S6, the chain state sensor S7, the speed sensor S8, the cadence sensor S9, and the crank power sensor S10 can include wireless communicator circuitry configured to wirelessly communicate with wireless communicator circuitry such as the first wireless communicator circuitry WC1, the second wireless communicator circuitry WC2, and the additional wireless communicator circuitry WC3.

The pressure sensor S1 is configured to wirelessly transmit the tire air pressure. The acceleration sensor S2 is configured to wirelessly transmit the vehicle acceleration. The handlebar load sensor S3 is configured to wirelessly transmit the handlebar load. The saddle load sensor S4 is configured to wirelessly transmit the saddle load. The assist power sensor S5 is configured to wirelessly transmit the assist power output. The rider motion sensor S6 is configured to wirelessly transmit the rider's motion. The chain state sensor S7 is configured to wirelessly transmit the chain state. The speed sensor S8 is configured to wirelessly transmit the running speed. The cadence sensor S9 is configured to wirelessly transmit the cadence. The crank power sensor S10 is configured to wirelessly transmit the crank torque.

The first wireless communicator circuitry WC1 is configured to wirelessly receive the tire air pressure, the vehicle acceleration, the handlebar load, the saddle load, the assist power output, the rider's motion, the chain state, the running speed, the cadence, and the crank torque from the pressure sensor S1, the acceleration sensor S2, the handlebar load sensor S3, the saddle load sensor S4, the assist power sensor S5, the chain state sensor S7, the speed sensor S8, the cadence sensor S9, and the crank power sensor S10. The electronic controller circuitry EC1, EC2, or EC3 is configured to obtain the tire air pressure, the vehicle acceleration, the handlebar load, the saddle load, the assist power output, the rider's motion, the chain state, the running speed, the cadence, and the crank torque from the pressure sensor S1, the acceleration sensor S2, the handlebar load sensor S3, the saddle load sensor S4, the assist power sensor S5, the rider motion sensor S6, the chain state sensor S7, the speed sensor S8, the cadence sensor S9, and the crank power sensor S10.

In the modification depicted in FIG. 18, the electronic controller circuitry EC1, EC2, or EC3 can be configured to generate at least one control signal CS2 based on the motion information INF2. One of the wireless communicator circuitry WC1, WC2, and WC3 is configured to wirelessly transmit the at least one control signal CS2. Another of the wireless communicator circuitry WC1, WC2, and WC3 is configured to wirelessly receive the at least one control signal CS2.

The motion information INF2 relates to whether a motion state of the rider falls outside a predetermined range. The motion information INF2 includes fluctuation in a running condition of the human-powered vehicle 2 for a predetermined time. The fluctuation in the running condition relates to at least one of the tire air pressure, the vehicle acceleration, the handlebar load, the saddle load, the assist power output, the rider's motion, the chain state, and the running speed of the human-powered vehicle 2. The fluctuation in the running condition relates to at least one of the tire air pressure, the vehicle acceleration, the handlebar load, the saddle load, the assist power output, the rider's motion, the chain state, the running speed, the cadence, and the crank torque of the human-powered vehicle 2.

The motion information INF2 includes that the tire air pressure is greater or less than a pressure threshold for the predetermined time. The motion information INF2 includes that the vehicle acceleration is greater or less than an acceleration threshold for the predetermined time. The motion information INF2 includes that the handlebar load is greater or less than a handlebar load threshold for the predetermined time. The motion information INF2 includes that the saddle load is greater or less than a saddle load threshold for the predetermined time. The motion information INF2 includes that the assist power output is greater or less than a power threshold for the predetermined time. The motion information INF2 includes that the rider's motion is greater or less than a rider motion threshold for the predetermined time. The motion information INF2 includes that the chain state is greater or less than a chain state threshold for the predetermined time. The motion information INF2 includes that the running speed is greater or less than a speed threshold for the predetermined time. The motion information INF2 includes that the cadence is greater or less than a cadence threshold for the predetermined time. The motion information INF2 includes that the crank torque is greater or less than a torque threshold for the predetermined time.

In the modification depicted in FIG. 18, the electronic controller circuitry EC1, EC2, or EC3 can be configured to limit, based on the at least one control signal CS2, a function of the device ED which is functional with respect to the human-powered vehicle 2. The device ED includes at least one of the operating device ST, the adjustable seatpost AS, the gear changer RD, the suspension SS, the brake device BD, the assist drive unit DU, and the wearable device WD.

For example, the electronic controller circuitry EC1, EC2, or EC3 is configured to generate at least one control signal CS21 in a case where the tire air pressure is greater than the pressure threshold for the predetermined time. One of the wireless communicator circuitry WC1, WC2, and WC3 is configured to wirelessly transmit the at least one control signal CS21. Another of the wireless communicator circuitry WC1, WC2, and WC3 is configured to wirelessly receive the at least one control signal CS21. The electronic controller circuitry EC1, EC2, or EC3 is configured to limit the function of the device ED based on the at least one control signal CS21. The device ED is configured to limit the function of the device ED based on the at least one control signal CS21.

The electronic controller circuitry EC1, EC2, or EC3 is configured to generate at least one control signal CS22 in a case where the vehicle acceleration is greater than the acceleration threshold for the predetermined time. One of the wireless communicator circuitry WC1, WC2, and WC3 is configured to wirelessly transmit the at least one control signal CS22. Another of the wireless communicator circuitry WC1, WC2, and WC3 is configured to wirelessly receive the at least one control signal CS22. The electronic controller circuitry EC1, EC2, or EC3 is configured to limit the function of the device ED based on the at least one control signal CS22. The device ED is configured to limit the function of the device ED based on the at least one control signal CS22.

The electronic controller circuitry EC1, EC2, or EC3 is configured to generate at least one control signal CS23 in a case where the handlebar load is greater than the handlebar load threshold for the predetermined time. One of the wireless communicator circuitry

WC1, WC2, and WC3 is configured to wirelessly transmit the at least one control signal CS23. Another of the wireless communicator circuitry WC1, WC2, and WC3 is configured to wirelessly receive the at least one control signal CS23. The electronic controller circuitry EC1, EC2, or EC3 is configured to limit the function of the device ED based on the at least one control signal CS23. The device ED is configured to limit the function of the device ED based on the at least one control signal CS23.

The electronic controller circuitry EC1, EC2, or EC3 is configured to generate at least one control signal CS24 in a case where the saddle load is greater than the saddle load threshold for the predetermined time. One of the wireless communicator circuitry WC1, WC2, and WC3 is configured to wirelessly transmit the at least one control signal CS24. Another of the wireless communicator circuitry WC1, WC2, and WC3 is configured to wirelessly receive the at least one control signal CS24. The electronic controller circuitry EC1, EC2, or EC3 is configured to limit the function of the device ED based on the at least one control signal CS24. The device ED is configured to limit the function of the device ED based on the at least one control signal CS24.

The electronic controller circuitry EC1, EC2, or EC3 is configured to generate at least one control signal CS25 in a case where the assist power output is greater than the power threshold for the predetermined time. One of the wireless communicator circuitry WC1, WC2, and WC3 is configured to wirelessly transmit the at least one control signal CS25. Another of the wireless communicator circuitry WC1, WC2, and WC3 is configured to wirelessly receive the at least one control signal CS25. The electronic controller circuitry EC1, EC2, or EC3 is configured to limit the function of the device ED based on the at least one control signal CS25. The device ED is configured to limit the function of the device ED based on the at least one control signal CS25.

The electronic controller circuitry EC1, EC2, or EC3 is configured to generate at least one control signal CS26 in a case where the rider's motion is greater than the rider motion threshold for the predetermined time. One of the wireless communicator circuitry WC1, WC2, and WC3 is configured to wirelessly transmit the at least one control signal CS26. Another of the wireless communicator circuitry WC1, WC2, and WC3 is configured to wirelessly receive the at least one control signal CS26. The electronic controller circuitry EC1, EC2, or EC3 is configured to limit the function of the device ED based on the at least one control signal CS26. The device ED is configured to limit the function of the device ED based on the at least one control signal CS26.

The electronic controller circuitry EC1, EC2, or EC3 is configured to generate at least one control signal CS27 in a case where the chain state is greater than the chain state threshold for the predetermined time. One of the wireless communicator circuitry WC1, WC2, and WC3 is configured to wirelessly transmit the at least one control signal CS27. Another of the wireless communicator circuitry WC1, WC2, and WC3 is configured to wirelessly receive the at least one control signal CS27. The electronic controller circuitry EC1, EC2, or EC3 is configured to limit the function of the device ED based on the at least one control signal CS27. The device ED is configured to limit the function of the device ED based on the at least one control signal CS27.

The electronic controller circuitry EC1, EC2, or EC3 is configured to generate at least one control signal CS28 in a case where the running speed is greater than a speed threshold for the predetermined time. One of the wireless communicator circuitry WC1, WC2, and WC3 is configured to wirelessly transmit the at least one control signal CS28. Another of the wireless communicator circuitry WC1, WC2, and WC3 is configured to wirelessly receive the at least one control signal CS28. The electronic controller circuitry EC1, EC2, or EC3 is configured to limit the function of the device ED based on the at least one control signal CS28. The device ED is configured to limit the function of the device ED based on the at least one control signal CS28.

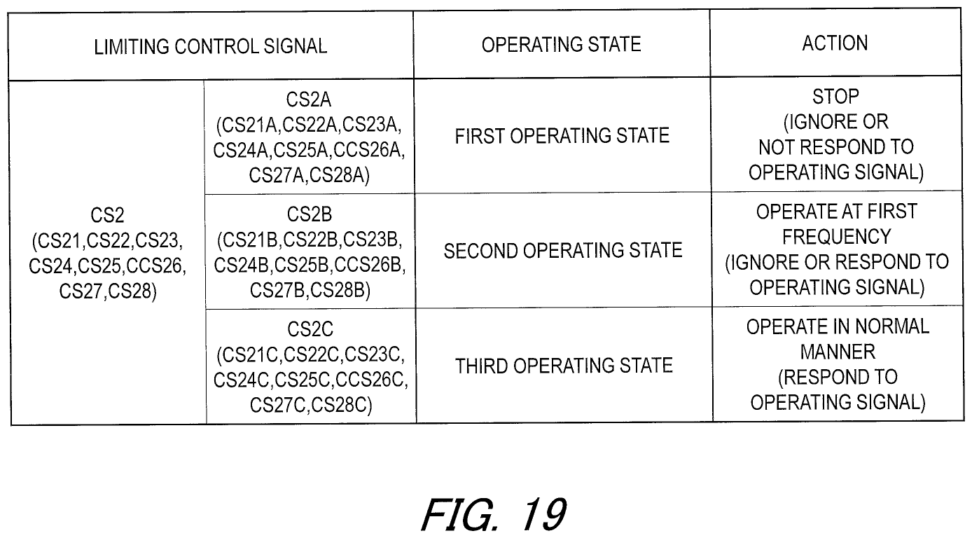

As seen in FIG. 19, in the modification depicted in FIG. 18, the at least one control signal CS2 includes at least: a first limiting control signal CS2A to limit the function of the device ED to a first operating state; a second limiting control signal CS2B to set the device ED to a second operating state different from the first operating state; and a third limiting control signal CS2C to set the device ED to a third operating state different from the first operating state and the second operating state.

For example, the device ED is configured to change a state of the device ED to the first operating state in response to the first limiting control signal CS2A. The device ED is configured to change the state of the device ED to the second operating state in response to the second limiting control signal CS2B. The device ED is configured to change the state of the device ED to the third operating state in response to the third limiting control signal CS2C.

For example, the device ED is configured to stop in the first operating state. In the first operating state, the device ED is configured to ignore or not respond to the operating signal SG1 transmitted from the operating device ST. Thus, the function of the device ED is limited in the first operating state. The electronic controller circuitry EC1, EC2, or EC3 is configured to limit the function of the device ED based the control signal CS2A.

The device ED is configured to operate at a first frequency in the second operating state. In the second operating state, the device ED is configured to listen to the operating signal SG1 during a first period and to ignore the operating signal SG1 during a second period. The device ED is configured to repeat the first period and the second period at the first frequency. Thus, the function of the device ED is limited in the second operating state. The electronic controller circuitry EC1, EC2, or EC3 is configured to limit the function of the device ED based the control signal CS2B. The power consumption of the device ED in the second operating state is higher than the power consumption of the device ED in the first operating state.

The device ED is configured to operate in a normal manner in the third operating state. In the third operating state, the device ED is configured to respond to the operating signal SG1. Thus, the function of the device ED is not limited in the third operating state. The power consumption of the device ED in the third operating state is higher than the power consumption of the device ED in each of the first operating state and the second operating state.

In the third operating state, the device ED is configured to operate in a first direction in response to a first operating signal included in the operating signal SG. The device ED is configured to operate in a second direction in response to a second operating signal included in the operating signal SG. The second direction is different from the first direction.

The device ED can be configured to operate in only one of the first direction and the second direction in the second operating state rather than operating at the first frequency. In this case, the function of the device ED is limited in the second operating state. The electronic controller circuitry EC1, EC2, or EC3 is configured to limit the function of the device ED based the control signal CS2B. The power consumption of the device ED in the second operating state is higher than the power consumption of the device ED in the first operating state.

At least one of the first limiting control signal CS2A, the second limiting control signal CS2B, and the third limiting control signal CS2C can be omitted from the control signal CS2 if needed or desired. At least one of the first operating state, the second operating state, and the third operating state can be omitted from the state of the device ED if needed or desired.

As seen in FIG. 19, the control signal CS21 includes at least: a first limiting control signal CS21A to limit the function of the device ED to the first operating state; a second limiting control signal CS21B to set the device ED to the second operating state different from the first operating state; and a third limiting control signal CS21C to set the device ED to the third operating state different from the first operating state and the second operating state.

For example, the device ED is configured to change the state of the device ED to the first operating state in response to the first limiting control signal CS21A. The device ED is configured to change the state of the device ED to the second operating state in response to the second limiting control signal CS21B. The device ED is configured to change the state of the device ED to the third operating state in response to the third limiting control signal CS21C. Thus, the electronic controller circuitry EC1, EC2, or EC3 is configured to limit the function of the device ED based each of the control signals CS21A and CS21B.

At least one of the first limiting control signal CS21A, the second limiting control signal CS21B, and the third limiting control signal CS21C can be omitted from the control signal CS21 if needed or desired.

As seen in FIG. 19, the control signal CS22 includes at least: a first limiting control signal CS22A to limit the function of the device ED to the first operating state; a second limiting control signal CS22B to set the device ED to the second operating state different from the first operating state; and a third limiting control signal CS22C to set the device ED to the third operating state different from the first operating state and the second operating state.

For example, the device ED is configured to change the state of the device ED to the first operating state in response to the first limiting control signal CS22A. The device ED is configured to change the state of the device ED to the second operating state in response to the second limiting control signal CS22B. The device ED is configured to change the state of the device ED to the third operating state in response to the third limiting control signal CS22C. Thus, the electronic controller circuitry EC1, EC2, or EC3 is configured to limit the function of the device ED based each of the control signals CS22A and CS22B.

At least one of the first limiting control signal CS22A, the second limiting control signal CS22B, and the third limiting control signal CS22C can be omitted from the control signal CS22 if needed or desired.

As seen in FIG. 19, the control signal CS23 includes at least: a first limiting control signal CS23A to limit the function of the device ED to the first operating state; a second limiting control signal CS23B to set the device ED to the second operating state different from the first operating state; and a third limiting control signal CS23C to set the device ED to the third operating state different from the first operating state and the second operating state.

For example, the device ED is configured to change the state of the device ED to the first operating state in response to the first limiting control signal CS23A. The device ED is configured to change the state of the device ED to the second operating state in response to the second limiting control signal CS23B. The device ED is configured to change the state of the device ED to the third operating state in response to the third limiting control signal CS23C. Thus, the electronic controller circuitry EC1, EC2, or EC3 is configured to limit the function of the device ED based each of the control signals CS23A and CS23B.

At least one of the first limiting control signal CS23A, the second limiting control signal CS23B, and the third limiting control signal CS23C can be omitted from the control signal CS23 if needed or desired.

As seen in FIG. 19, the control signal CS24 includes at least: a first limiting control signal CS24A to limit the function of the device ED to the first operating state; a second limiting control signal CS24B to set the device ED to the second operating state different from the first operating state; and a third limiting control signal CS24C to set the device ED to the third operating state different from the first operating state and the second operating state.

For example, the device ED is configured to change the state of the device ED to the first operating state in response to the first limiting control signal CS24A. The device ED is configured to change the state of the device ED to the second operating state in response to the second limiting control signal CS24B. The device ED is configured to change the state of the device ED to the third operating state in response to the third limiting control signal CS24C. Thus, the electronic controller circuitry EC1, EC2, or EC3 is configured to limit the function of the device ED based each of the control signals CS24A and CS24B.

At least one of the first limiting control signal CS24A, the second limiting control signal CS24B, and the third limiting control signal CS24C can be omitted from the control signal CS24 if needed or desired.

As seen in FIG. 19, the control signal CS25 includes at least: a first limiting control signal CS25A to limit the function of the device ED to the first operating state; a second limiting control signal CS25B to set the device ED to the second operating state different from the first operating state; and a third limiting control signal CS25C to set the device ED to the third operating state different from the first operating state and the second operating state.

For example, the device ED is configured to change the state of the device ED to the first operating state in response to the first limiting control signal CS25A. The device ED is configured to change the state of the device ED to the second operating state in response to the second limiting control signal CS25B. The device ED is configured to change the state of the device ED to the third operating state in response to the third limiting control signal CS25C. Thus, the electronic controller circuitry EC1, EC2, or EC3 is configured to limit the function of the device ED based each of the control signals CS25A and CS25B.

At least one of the first limiting control signal CS25A, the second limiting control signal CS25B, and the third limiting control signal CS25C can be omitted from the control signal CS25 if needed or desired.

As seen in FIG. 19, the control signal CS26 includes at least: a first limiting control signal CS26A to limit the function of the device ED to the first operating state; a second limiting control signal CS26B to set the device ED to the second operating state different from the first operating state; and a third limiting control signal CS26C to set the device ED to the third operating state different from the first operating state and the second operating state.

For example, the device ED is configured to change the state of the device ED to the first operating state in response to the first limiting control signal CS26A. The device ED is configured to change the state of the device ED to the second operating state in response to the second limiting control signal CS26B. The device ED is configured to change the state of the device ED to the third operating state in response to the third limiting control signal CS26C. Thus, the electronic controller circuitry EC1, EC2, or EC3 is configured to limit the function of the device ED based each of the control signals CS26A and CS26B.

At least one of the first limiting control signal CS26A, the second limiting control signal CS26B, and the third limiting control signal CS26C can be omitted from the control signal CS26 if needed or desired.

As seen in FIG. 19, the control signal CS27 includes at least: a first limiting control signal CS27A to limit the function of the device ED to the first operating state; a second limiting control signal CS27B to set the device ED to the second operating state different from the first operating state; and a third limiting control signal CS27C to set the device ED to the third operating state different from the first operating state and the second operating state.

For example, the device ED is configured to change the state of the device ED to the first operating state in response to the first limiting control signal CS27A. The device ED is configured to change the state of the device ED to the second operating state in response to the second limiting control signal CS27B. The device ED is configured to change the state of the device ED to the third operating state in response to the third limiting control signal CS27C. Thus, the electronic controller circuitry EC1, EC2, or EC3 is configured to limit the function of the device ED based each of the control signals CS27A and CS27B.

At least one of the first limiting control signal CS27A, the second limiting control signal CS27B, and the third limiting control signal CS27C can be omitted from the control signal CS27 if needed or desired.

As seen in FIG. 19, the control signal CS28 includes at least: a first limiting control signal CS28A to limit the function of the device ED to the first operating state; a second limiting control signal CS28B to set the device ED to the second operating state different from the first operating state; and a third limiting control signal CS28C to set the device ED to the third operating state different from the first operating state and the second operating state.

For example, the device ED is configured to change the state of the device ED to the first operating state in response to the first limiting control signal CS28A. The device ED is configured to change the state of the device ED to the second operating state in response to the second limiting control signal CS28B. The device ED is configured to change the state of the device ED to the third operating state in response to the third limiting control signal CS28C. Thus, the electronic controller circuitry EC1, EC2, or EC3 is configured to limit the function of the device ED based each of the control signals CS28A and CS28B.

At least one of the first limiting control signal CS28A, the second limiting control signal CS28B, and the third limiting control signal CS28C can be omitted from the control signal CS28 if needed or desired.

In a case where the device ED includes the adjustable seatpost AS, in the first operating state, the adjustable seatpost AS is configured to maintain the length of the adjustable seatpost AS regardless of the operating signal SG1. In the second operating state, the adjustable seatpost AS is configured to maintain the length of the adjustable seatpost AS during the first period regardless of the operating signal SG1 and configured to change the length of the adjustable seatpost AS in response to the operating signal SG1 during the second period. In the third operating state, the adjustable seatpost AS is configured to change the length of the adjustable seatpost AS in response to the operating signal SG1.

In a case where the cadence is equal to or less than the cadence threshold and where the crank torque is equal to or less than the torque threshold, the electronic controller circuitry EC1, EC2, or EC3 is configured to generate the control signal CS2A to limit the function of the adjustable seatpost AS. The adjustable seatpost AS is configured to change the state of the adjustable seatpost AS to the first operating state in response to the control signal CS2A. Thus, the adjustable seatpost AS is configured to ignore or not respond to the operating signal SG1 in a case where the cadence is equal to or less than the cadence threshold and where the crank torque is equal to or less than the torque threshold. This case can include a state where the human-powered vehicle 2 stops, a standstill state, and a standing determination state. The standstill is a technique that the rider maintains balance while the human-powered vehicle 2 remains stationary or moves only minimal distances. In the standing determination state, it is determined whether the state of the human-powered vehicle 2 is standstill.

In a case where the cadence is greater than the cadence threshold, the electronic controller circuitry EC1, EC2, or EC3 is configured to generate the control signal CS2C. The adjustable seatpost AS is configured to change the state of the adjustable seatpost AS to the third operating state in response to the control signal CS2C. Thus, the adjustable seatpost AS is configured to ignore or not respond to the operating signal SG1 in a case where the cadence is greater than the cadence threshold.

In a case where the cadence is greater than the cadence threshold and where the inclination angle is greater than an inclination threshold, the human-powered vehicle 2 runs uphill. Thus, in such a case, the electronic controller circuitry EC1, EC2, or EC3 is configured to generate the control signal CS2A to limit the function of the adjustable seatpost AS. The adjustable seatpost AS is configured to change the state of the adjustable seatpost AS to the first operating state in response to the control signal CS2A. Thus, the adjustable seatpost AS is configured to ignore or not respond to the operating signal SG1 in a case where the cadence is greater than the cadence threshold and where the inclination angle is greater than the inclination threshold.

In a case where the cadence is greater than the cadence threshold and where the inclination angle is greater than the inclination threshold, the electronic controller circuitry EC1, EC2, or EC3 can be configured to generate the control signal CS2B to limit the function of the adjustable seatpost AS. The adjustable seatpost AS is configured to change the state of the adjustable seatpost AS to the second operating state in response to the control signal CS2B. Thus, the adjustable seatpost AS is configured to ignore or not respond to the first operating signal included in the operating signal SG1 in a case where the cadence is greater than the cadence threshold and where the inclination angle is greater than the inclination threshold. The adjustable seatpost AS is configured to operate in response to the second operating signal included in the operating signal SG1 in a case where the cadence is greater than the cadence threshold and where the inclination angle is greater than the inclination threshold. For example, the first direction corresponds to a direction in which the length of the adjustable seatpost AS decreases. The second direction corresponds to a direction in which the length of the adjustable seatpost AS increases.

In a case where the crank torque is greater than the torque threshold and where the inclination angle is greater than the inclination threshold, the human-powered vehicle 2 runs uphill. Thus, in such a case, the electronic controller circuitry EC1, EC2, or EC3 is configured to generate the control signal CS2A to limit the function of the adjustable seatpost AS. The adjustable seatpost AS is configured to change the state of the adjustable seatpost AS to the first operating state in response to the control signal CS2A. Thus, the adjustable seatpost AS is configured to ignore or not respond to the operating signal SG1 in a case where the crank torque is greater than the torque threshold and where the inclination angle is greater than the inclination threshold.

In a case where the crank torque is greater than the torque threshold and where the inclination angle is greater than the inclination threshold, the electronic controller circuitry EC1, EC2, or EC3 can be configured to generate the control signal CS2B to limit the function of the adjustable seatpost AS. The adjustable seatpost AS is configured to change the state of the adjustable seatpost AS to the second operating state in response to the control signal CS2B. Thus, the adjustable seatpost AS is configured to ignore or not respond to the first operating signal included in the operating signal SG1 in a case where the cadence is greater than the cadence threshold and where the inclination angle is greater than the inclination threshold. The adjustable seatpost AS is configured to operate in response to the second operating signal included in the operating signal SG1 in a case where the crank torque is greater than the torque threshold and where the inclination angle is greater than the inclination threshold. For example, the first direction corresponds to a direction in which the length of the adjustable seatpost AS decreases. The second direction corresponds to a direction in which the length of the adjustable seatpost AS increases.

In a case where a vertical component of the vehicle acceleration is greater than the acceleration threshold and where the inclination angle is less than the inclination threshold, the human-powered vehicle 2 runs downhill. Thus, in such a case, the electronic controller circuitry EC1, EC2, or EC3 is configured to generate the control signal CS2A to limit the function of the adjustable seatpost AS. The adjustable seatpost AS is configured to change the state of the adjustable seatpost AS to the first operating state in response to the control signal CS2A. Thus, the adjustable seatpost AS is configured to ignore or not respond to the operating signal SG1 in a case where the vertical component of the vehicle acceleration is greater than the acceleration threshold and where the inclination angle is less than the inclination threshold.

In a case where the vertical component of the vehicle acceleration is greater than the acceleration threshold and where the inclination angle is less than the inclination threshold, the electronic controller circuitry EC1, EC2, or EC3 can be configured to generate the control signal CS2B to limit the function of the adjustable seatpost AS. The adjustable seatpost AS is configured to change the state of the adjustable seatpost AS to the second operating state in response to the control signal CS2B. Thus, the adjustable seatpost AS is configured to ignore or not respond to the first operating signal included in the operating signal SG1 in a case where the vertical component of the vehicle acceleration is greater than the acceleration threshold and where the inclination angle is less than the inclination threshold. The adjustable seatpost AS is configured to operate in response to the second operating signal included in the operating signal SG1 in a case where the vertical component of the vehicle acceleration is greater than the acceleration threshold and where the inclination angle is less than the inclination threshold. For example, the first direction corresponds to a direction in which the length of the adjustable seatpost AS decreases. The second direction corresponds to a direction in which the length of the adjustable seatpost AS increases.

In a case where the running speed is greater than the speed threshold and where the inclination angle is less than the inclination threshold, the human-powered vehicle 2 runs downhill. Thus, in such a case, the electronic controller circuitry EC1, EC2, or EC3 is configured to generate the control signal CS2A to limit the function of the adjustable seatpost

AS. The adjustable seatpost AS is configured to change the state of the adjustable seatpost AS to the first operating state in response to the control signal CS2A. Thus, the adjustable seatpost AS is configured to ignore or not respond to the operating signal SG1 in a case where the running speed is greater than the speed threshold and where the inclination angle is less than the inclination threshold.

In a case where the running speed is greater than the speed threshold and where the inclination angle is less than the inclination threshold, the electronic controller circuitry EC1, EC2, or EC3 can be configured to generate the control signal CS2B to limit the function of the adjustable seatpost AS. The adjustable seatpost AS is configured to change the state of the adjustable seatpost AS to the second operating state in response to the control signal CS2B. Thus, the adjustable seatpost AS is configured to ignore or not respond to the second operating signal included in the operating signal SG1 in a case where the cadence is greater than the cadence threshold and where the inclination angle is greater than the inclination threshold. The adjustable seatpost AS is configured to operate in response to the first operating signal included in the operating signal SG1 in a case where the running speed is greater than the speed threshold and where the inclination angle is less than the inclination threshold. For example, the first direction corresponds to a direction in which the length of the adjustable seatpost AS decreases. The second direction corresponds to a direction in which the length of the adjustable seatpost AS increases.

In a case where the saddle load is greater than the saddle load threshold, the user sits on the saddle 8S and/or applies load in the transverse direction. In a case where the first saddle load is greater than a first saddle load threshold and/or where the second saddle load is greater than a second saddle load threshold, the electronic controller circuitry EC1, EC2, or EC3 is configured to generate the control signal CS2A to limit the function of the adjustable seatpost AS. The adjustable seatpost AS is configured to change the state of the adjustable seatpost AS to the first operating state in response to the control signal CS2A. Thus, the adjustable seatpost AS is configured to ignore or not respond to the operating signal SG1 in a case where the saddle load is greater than the saddle load threshold. The adjustable seatpost AS is configured to ignore or not respond to the operating signal SG1 in a case where the first saddle load is greater than a first saddle load threshold and/or where the second saddle load is greater than a second saddle load threshold.

In a case where the crank torque is greater than the torque threshold, the electronic controller circuitry EC1, EC2, or EC3 is configured to generate the control signal CS2A to limit the function of the adjustable seatpost AS. The adjustable seatpost AS is configured to change the state of the adjustable seatpost AS to the first operating state in response to the control signal CS2A. Thus, the adjustable seatpost AS is configured to ignore or not respond to the operating signal SG1 in a case where the crank torque is greater than the torque threshold.

The electronic controller circuitry EC1, EC2, or EC3 can include a power source sensor. The power source sensor is configured to obtain a remaining level of the electric power source of the device ED. In a case where the remaining level is lower than a remaining level threshold, the electronic controller circuitry EC1, EC2, or EC3 is configured to generate the control signal CS2B to limit the function of the adjustable seatpost AS. The adjustable seatpost AS is configured to change the state of the adjustable seatpost AS to the second operating state in response to the control signal CS2B. Thus, the adjustable seatpost AS is configured to operate at the first frequency in a case where the remaining level is lower than the remaining level threshold. This can reduce the power consumption of the electric power source of the device ED.

In a case where the rider's motion is less than the rider motion threshold for the predetermined time, the electronic controller circuitry EC1, EC2, or EC3 is configured to generate the control signal CS2B to limit the function of the adjustable seatpost AS. The adjustable seatpost AS is configured to change the state of the adjustable seatpost AS to the second operating state in response to the control signal CS2B. Thus, the adjustable seatpost AS is configured to operate at the first frequency in a case where the rider's motion is less than the rider motion threshold for the predetermined time.

In a case where a change in the vehicle speed is greater than a speed threshold, the human-powered vehicle 2 is slowing down. Thus, in such a case, the electronic controller circuitry EC1, EC2, or EC3 is configured to generate the control signal CS2B to limit the function of the adjustable seatpost AS. The adjustable seatpost AS is configured to change the state of the adjustable seatpost AS to the second operating state in response to the control signal CS2B. Thus, the adjustable seatpost AS is configured to ignore or not respond to the second operating signal included in the operating signal SG1 in a case where the change in the vehicle speed is greater than a speed threshold. The adjustable seatpost AS is configured to operate in response to the first operating signal included in the operating signal SG1 in a case where the change in the vehicle speed is greater than a speed threshold. For example, the first direction corresponds to a direction in which the length of the adjustable seatpost AS decreases. The second direction corresponds to a direction in which the length of the adjustable seatpost AS increases.

In a case where the cadence is zero and where the crank torque is zero, the human-powered vehicle 2 does not run or is being transported. In such a case, the electronic controller circuitry EC1, EC2, or EC3 is configured to generate the control signal CS2A to limit the function of the adjustable seatpost AS. The adjustable seatpost AS is configured to change the state of the adjustable seatpost AS to the first operating state in response to the control signal CS2A. Thus, the adjustable seatpost AS is configured to ignore or not respond to the operating signal SG1 in a case where the cadence is zero and where the crank torque is zero.

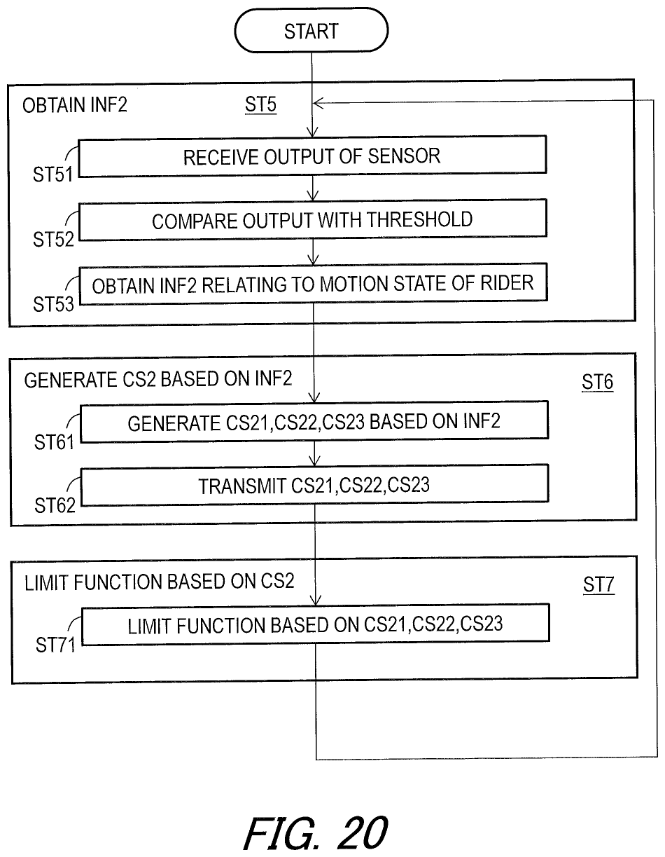

The second control executed by the control system 10 based on the motion information INF2 will be described below referring to FIG. 20.

As seen in FIG. 20, the electronic controller circuitry EC1 obtains the motion information INF2 (step ST6). For example, the electronic controller circuitry EC1, EC2, or EC3 obtain the output of at least one of the sensors S1 to S10 (step ST61). The electronic controller circuitry EC1, EC2, or EC3 compares the output with a threshold (step ST62). The electronic controller circuitry EC1, EC2, or EC3 obtain the motion information INF2 relating to whether the motion state of the rider falls outside the predetermined range (step ST63).

The electronic controller circuitry EC1, EC2, or EC3 generates the at least one control signal CS2 based on the motion information INF2 (step ST7). For example, the electronic controller circuitry EC1, EC2, or EC3 generates the control signal CS21, CS22, or CS3 based on the motion information INF2 (step ST71). The electronic controller circuitry EC1, EC2, or EC3 controls the wireless communicator circuitry WC1, WC2, or WC3 to wirelessly transmit the control signal CS21, CS22, or CS3 (step ST72).

The device ED limits the function of the device ED based on the at least one control signal CS2 (step ST8). The device ED limits the function of the device ED based on the control signal CS21, CS22, or CS23 (step ST81).

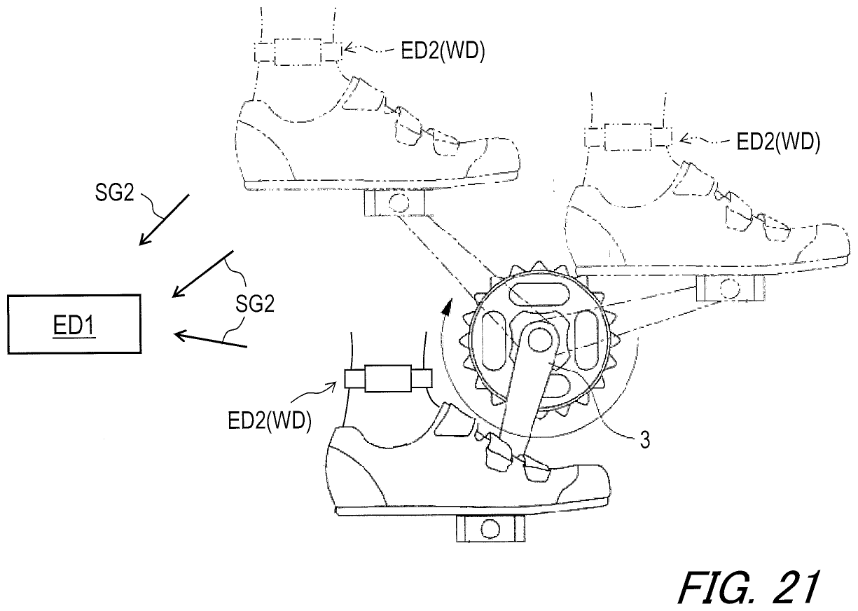

As seen in FIG. 21, the wearable device WD can be configured to be attached to a leg of the rider. In such modifications, as seen in FIG. 4, the second electric device ED2 includes the wearable device WD. The second electric device ED2 wirelessly transmits the direction-funding signal SG2. The electric device ED1 calculates the angle of arrival AG1 or the angle of departure AG2 as the information INF1. The angle of arrival AG1 or the angle of departure AG2 changes during pedaling. The cycle of fluctuation in the angle of arrival AG1 or the angle of departure AG2 represents a cadence. Thus, the electric device

ED1 can be configured to obtain the cadence based the information INF1 in a case where the wearable device WD is attached to the leg of the rider.

In the present application, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. This concept also applies to words of similar meaning, for example, the terms “have,” “include” and their derivatives.

The terms “member,” “section,” “portion,” “part,” “element,” “body” and “structure” when used in the singular can have the dual meaning of a single part or a plurality of parts.

The ordinal numbers such as “first” and “second” recited in the present application are merely identifiers, but do not have any other meanings, for example, a particular order and the like. Moreover, for example, the term “first element” itself does not imply an existence of “second element,” and the term “second element” itself does not imply an existence of “first element.”

The term “pair of,” as used herein, can encompass the configuration in which the pair of elements have different shapes or structures from each other in addition to the configuration in which the pair of elements have the same shapes or structures as each other.

The terms “a” (or “an”), “one or more” and “at least one” can be used interchangeably herein.

The phrase “at least one of” as used in this disclosure means “one or more” of a desired choice. For one example, the phrase “at least one of” as used in this disclosure means “only one single choice” or “both of two choices” if the number of its choices is two. For other example, the phrase “at least one of” as used in this disclosure means “only one single choice” or “any combination of equal to or more than two choices” if the number of its choices is equal to or more than three. For instance, the phrase “at least one of A and B” encompasses (1) A alone, (2), B alone, and (3) both A and B. The phrase “at least one of A, B, and C” encompasses (1) A alone, (2), B alone, (3) C alone, (4) both A and B, (5) both B and C, (6) both A and C, and (7) all A, B, and C. In other words, the phrase “at least one of A and B” does not mean “at least one of A and at least one of B” in this disclosure.

Finally, terms of degree such as “substantially,” “about” and “approximately” as used herein mean a reasonable amount of deviation of the modified term such that the end result is not significantly changed. All of numerical values described in the present application can be construed as including the terms such as “substantially,” “about” and “approximately.”

Obviously, numerous modifications and variations of the present invention are possible in light of the above teachings. It is therefore to be understood that within the scope of the appended claims, the invention may be practiced otherwise than as specifically described herein.

What is claimed is:

1. An electric device of a human-powered vehicle, the electric device comprising:
first wireless communicator circuitry configured to wirelessly communicate with second wireless communicator circuitry of a second electric device; and
electronic controller circuitry electrically connected to the first wireless communicator circuitry, the electronic controller circuitry being configured to obtain information relating to a positional relationship between the first wireless communicator circuitry and the second wireless communicator circuitry so as to generate at least one control signal based on the information.

2. The electric device according to claim 1, wherein
the information includes directional information relating to a directional relationship between the first wireless communicator circuitry and the second wireless communicator circuitry in the human-powered vehicle, and
the electronic controller circuitry is configured to obtain the directional information.

3. The electric device according to claim 2, wherein
the electronic controller circuitry is configured to generate the at least one control signal based on the directional information.

4. The electric device according to claim 2, wherein
the directional information includes an angle of arrival defined based on a relative position between the first wireless communicator circuitry and the second wireless communicator circuitry, and
the electronic controller circuitry is configured to obtain the angle of arrival.

5. The electric device according to claim 4, wherein
the electronic controller circuitry is configured to generate the at least one control signal based on the angle of arrival.

6. The electric device according to claim 4, wherein
the first wireless communicator circuitry includes at least two first antennas.

7. The electric device according to claim 6, wherein
a total number of the at least two first antennas is greater than or equal to three.

8. The electric device according to claim 6, wherein
the at least two first antennas are equally spaced.

9. The electric device according to claim 4, wherein
the angle of arrival is defined based on a positional relationship between the at least two first antennas and a second antenna of the second wireless communicator circuitry in the human-powered vehicle.

10. The electric device according to claim 2, wherein
the directional information includes an angle of departure defined based on a relative position between the first wireless communicator circuitry and the second wireless communicator circuitry, and
the electronic controller circuitry is configured to obtain the angle of departure.

11. The electric device according to claim 10, wherein
the electronic controller circuitry is configured to generate the at least one control signal based on the angle of departure.

12. The electric device according to claim 10, wherein
the first wireless communicator circuitry includes a first antenna.

13. The electric device according to claim 10, wherein
the angle of departure is defined based on a positional relationship between the first antenna and at least two second antennas of the second wireless communicator circuitry in the human-powered vehicle.

14. The electric device according to claim 1, further comprising
one of an operating device, an adjustable seatpost, a gear changer, a suspension, a brake device, an assist drive unit, and a wearable device.

15. The electric device according to claim 14, wherein
the second electric device includes another of the operating device, the adjustable seatpost, the gear changer, the suspension, the brake device, the assist drive unit, and the wearable device.

16. A control system of a human-powered vehicle, the control system comprising
the electric device according to claim 1;
a sensor configured to be connected to at least one of the first wireless communicator circuitry, the second wireless communicator circuitry and the electronic controller circuitry, the sensor being configured to transmit the information relating to the positional relationship to the electronic controller circuitry; and
an additional electric device configured to be controlled by at least one control signal generated by the electronic controller circuitry.

17. The control system according to claim 16, wherein
the additional electric device includes one of the adjustable seatpost, the gear changer, the suspension, the brake device, and the assist drive unit.

18. A control system of a human-powered vehicle, the control system comprising:
electronic controller circuitry configured to generate at least one control signal based on motion information relating to whether a motion state of a rider falls outside a predetermined range, the electronic controller circuitry being configured to limit, based on the at least one control signal, a function of a device which is functional with respect to the human-powered vehicle.

19. The control system according to claim 18, wherein
the motion information includes fluctuation in a running condition of the human-powered vehicle for a predetermined time.

20. The control system according to claim 19, wherein
the fluctuation in the running condition relates to at least one of a tire air pressure, a vehicle acceleration, a handlebar load, a saddle load, an assist power output, a rider's motion, a chain state, and a running speed of the human-powered vehicle.

21. The control system according to claim 18, wherein
the at least one control signal includes at least:
a first limiting control signal to limit the function of the device to a first operating state;
a second limiting control signal to set the device to a second operating state different from the first operating state; and
a third limiting control signal to set the device to a third operating state different from the first operating state and the second operating state.

22. The electric device according to claim 1, wherein
the electronic controller circuitry is configured to generate the at least one control signal to change a state of a suspension between at least two states based on the information.

23. The electric device according to claim 1, wherein
the electronic controller circuitry is configured to generate the at least one control signal to change a state of an adjustable seatpost between at least two states based on the information.

24. The electric device according to claim 1, wherein
the electronic controller circuitry is configured to generate the at least one control signal to restrict a brake device from generating a braking force based on the information.

25. The electric device according to claim 1, wherein
the electronic controller circuitry is configured to generate the at least one control signal to change an assist ratio of an assist drive unit based on the information.

26. The electric device according to claim 1, wherein
the electronic controller circuitry is configured to generate the at least one control signal to change a gear ratio of a gear changer based on the information.
